(19) United States
(12) Patent Application Publication
(10) Pub. No.: US 2025/0361335 A1
(43) Pub. Date: Nov. 27, 2025

(54) PREPARATION AND METHODS FOR THE MAKING OF AMINE CONTAINING POLYBUTADIENE POLYMERS

(71) Applicant: The University of British Columbia, Vancouver (CA)

(72) Inventors: Damon Gilmour, Saanich (CA); Sabrina Scott, Vancouver (CA); Laurel Schafer, Vancouver (CA); Patrick Brant, Seabrook, TX (US)

(21) Appl. No.: 18/856,026

(22) PCT Filed: Apr. 13, 2023
(86) PCT No.: PCT/CA2023/050508

§ 371 Date: Oct. 10, 2024

Related U.S. Application Data
(60) Provisional application No. 63/330,696, filed on Apr. 13, 2022.

(51) Int. Cl. C08F 8/32; C08F 8/02; C08F 8/04; C08F 8/10; C08F 8/14; C08F 8/44

(52) U.S. Cl. CPC C08F 8/32; C08F 8/02; C08F 8/04; C08F 8/10; C08F 8/14; C08F 8/44; C08F 2810/20

(57) ABSTRACT

The preparation of amine containing polymers from commodity polyolefins has been achieved through the functionalization of polybutadiene. The pre-functionalized polybutadiene is comprised of butadiene and optionally other monomers such as styrene. The butadiene monomer can be enchained with a mixture of both 1,4- and 1,2-subunits. Amine functionalization of the polybutadiene substrate has been afforded using a single step catalytic reaction termed hydroaminoalkylation (HAA).

### CROSS-REFERENCE TO RELATED APPLICATIONS

This application claims priority to, and the benefit of, U.S. Provisional Patent Application No. 63/330,696, filed Apr. 13, 2022, the entire contents of which are herein incorporated by reference in its entirety for all purposes.

### FIELD

The present disclosure provides hydroaminoalkylation reaction of polybutadiene for making aminated polybutadienes with branched pendant amine groups.

### BACKGROUND

The functionalization of polyolefins with polar groups is useful for myriad applications. Franssen et al., Chem. Soc. Rev. 2013, 42 (13): 5809-5832. Incorporation of amine functionality into polyolefins is attractive but remains relatively elusive by traditional routes. For example, amine-containing monomers are typically not compatible with the most commonly practiced polymerization methods, such as Ziegler-Natta, metallocene, or radical polymerization. Rare tertiary amine-containing monomers can be incorporated using some metallocene catalysis. Post-polymerization methods typically offer poor selectivity and/or atom efficiency. In other cases, organoaluminum protection of pendant amines has enabled incorporation in polyolefin chains through olefin-protected amine enchainment. This route has proven to be complicated by the difficulty of recycling the protected amine olefin, reactions of the protected amine olefin with impurities, and the expense and complexity of the deprotection step.

Thus, synthesizing amine functionalized polymers has remained a challenge due to the nucleophilicity and basicity of amines. Amines impede most polymerization mechanisms and are challenging to directly, and catalytically, install through metal-based reactions. In general, such routes are not facile; they can involve multiple steps and expensive reagents. Rodriguez et al., Macromolecules 2021, 54 (11): 4971-4985. While a challenge to install, amine functional groups can impart materials with modified polarity, hydrogen-bonding ability, and/or amphiphilic properties. Franssen et al., Chem. Soc. Rev. 2013, 42 (13): 5809-5832; Pelton, Langmuir 2014, 30 (51): 15373-15382; Gilmour et al., ACS Applied Polymer Materials 2021, 3 (5): 2330-2335; Kuanr et al., Macromolecules 2020, 53 (7): 2649-2661. Such amine containing materials could be useful as fuel additives and lubricants, within paints, adhesives and coatings, as components in drug delivery systems, anion exchange membranes, and reactive polymer blends compatible for immiscible polymer blends.

A common method for installing amines onto polyolefins involves functionalizing unsaturated polyolefins via a high-pressure reaction sequence of hydroformylation followed by reductive amination. This process is commonly referred to as a tandem process termed hydroaminomethylation/aminomethylation. Rodriguez et al., Macromolecules 2021, 54 (11): 4971-4985; McGrath et al., Chem. Rev. 1995, 95 (2): 381-398. Hydroaminomethylation/hydroformylation-reductive amination sequences typically favor C≡C bond formation on the terminal carbon of the pendant vinyl groups of the 1,2-polybutadiene repeat unit, providing the “linear” aminated variant. Although these are well-established methodologies in industry, these reactions result in stoichiometric waste and poor control over amine incorporation.

US Patent Application Publication No. US 2021/0002407 A1 disclose hydroformylation/reductive amination reaction sequences (also known as hydroaminomethylation) for installing amines onto polyolefins mixtures. The hydroaminomethylation reaction predominantly yielded the ‘linear’ product.

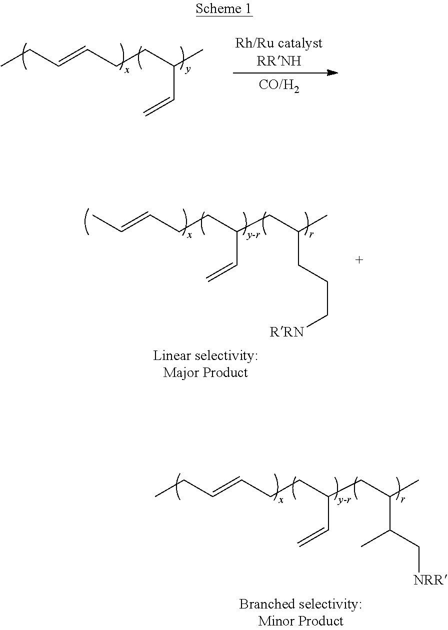

Hydroaminoalkylation offers some advantages as a one-step catalytic reaction that can effect direct amine functionalization on unsaturated polyolefins. Edwards et al., Chemical Communications 2018, 54 (89): 12543-12560. It has been recently reported that hydroaminoalkylation is an effective postpolymerization amination route to provide end-aminated polyolefins from vinyl terminated polypropylene. Scott et al., ACS Macro Letters 2021, 10 (10): 1266-1272; Daneshmand et al., J. Am. Chem. Soc. 2020, 142 (37): 15740-15750.

The present disclosure sets forth a one-step catalytic method for installing amine groups onto a polymer containing numerous points of unsaturation such as polybutadiene, which is unknown. Hydroaminoalkylation is a known method for functionalizing small molecules but has only been reported for polymer functionalization with polyolefins bearing a single reactive unsaturation at their terminus. Recent advances in the generation of highly electrophilic and robust early-transition metal catalysts have enabled the ability to predictably and efficiently install amine groups onto challenging polymer substrates without formation of stoichiometric waste products. The present disclosure sets forth highly electrophilic early-transition metal catalysts for efficiently installing amine groups onto polybutadiene substrates through hydroaminoalkylation, which was unknown prior to the instant disclosure herein.

### SUMMARY OF THE INVENTION

The disclosure described herein is based on the discovery that catalytic hydroaminoalkylation of polybutadiene to give aminated polybutadienes with predominant branched pendant amine functionality. This reaction can be applied with a broad scope of amines and polybutadiene polymer reactants to give products with controlled amine incorporation. The introduction of amines provides polar groups that improve the utility and applicability of these products.

The present disclosure includes hydroaminoalkylation reactions of unsaturated polyolefins with catalyst such as tantalum ureate complexes. Compared with related processes, such as Ta(NMe₂)₅ and Ta(NEt₂)₂Cl₃ catalysts in Hagadorn et al., U.S. Pat. No. 8,669,326, the instant processes have shorter reaction times, lower temperatures, and an expanded amine substrate scope to give products with controlled amine incorporation. A further advantage is the ability to perform the reactions set forth herein at ambient pressure. This reaction can enable new connection patterns by preferentially forming the branched product selectively with pendant vinyl groups; therefore, providing new matter compositions.

In a first embodiment provided herein is a polymer comprising:
a polybutadiene backbone;
1,2-alkene units,
1,4-alkenes units; and
a branched substitution unit having a functional group of Formula (I):

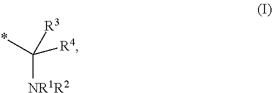

a linear substitution unit having a functional group of Formula (I):
   wherein the molar ratio of the branched substitution unit to the linear substitution unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —Cl, —I, —Br, —OH, —OCH₃, —OCF₃, and —C₁-C₆ thioalkyl, or a combination thereof;
R³ and R⁴ are, independently in each instance selected from H, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered in series, in blocks, or randomly distributed.

In a second embodiment provided herein is a polymer of Formula (II)

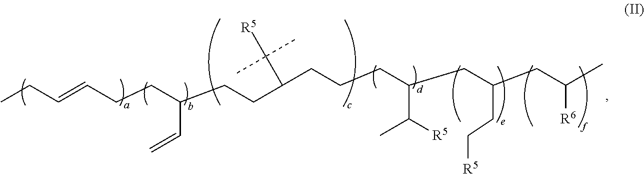

or a fragment thereof,
wherein
when R⁵ is present on the c unit, the dashed line indicates a single bond; when R⁵ is absent on the c unit, the dashed line is a double bond;
R⁵ is optionally a compound of Formula (I)

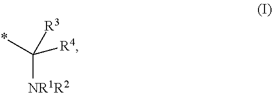

wherein
R¹ is —C₁-C₂₀ alkyl or —C₆-C₂₀ aryl; or
R² is hydrogen, —C₁-C₂₀ alkyl, or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R³ and R⁴ are each independently optionally substituted with one to six groups selected from —F, —Cl, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
R⁶ is hydrogen, —C₁-C₂₀ alkyl, —C₆-C₂₀ aryl, —C₁-C₆alkyl-C₁-C₂₀ alkyl, —C₁-6alkyl-C₆-C₂₀ aryl, —C₁₋₆heteroalkyl-C₁-C₂₀ alkyl, or —C₁-6heteroalkyl-C₆-C₂₀ aryl; and
a, b, c, d, e, and f are independently at each occurrence from 0 to 100,000; wherein the ratio of d:e is 6:1 or greater, wherein the units may be ordered or randomly distributed.

In a third embodiment provided herein is a polymer comprising:
a polybutadiene backbone;
1,2-alkene units,
1,4-alkenes units; and
a 1,4-addition unit substituted with a functional group of Formula (I):

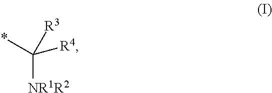

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —Cl, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other units; and
wherein the units may be ordered or randomly distributed.

In a fourth embodiment provided herein is a polymer comprising:
a polybutadiene backbone;
a unit comprising repeat units of 1,2-alkene,
a unit comprising repeat units of 1,4-alkenes; and
a branched-unit substituted with a functional group of Formula (I):

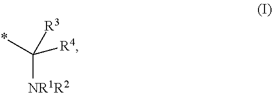

a linear-substitution unit having a functional group of Formula (I): wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —Cl, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In a fifth embodiment provided herein is a process of making a polymer comprising:
hydroaminoalkylating polybutadiene polymer post-polymerization in the presence of at least 5 mol % of group 4 or 5 transition metal catalyst and a secondary amine to form a functionalized polymer, wherein the reaction temperature is 110° C.-165° C.,
producing a polymer comprising
a polybutadiene backbone;
1,2-alkene units,
1,4-alkenes units; and
a branched-unit substituted with a functional group of Formula (I):

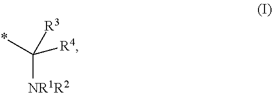

a linear substitution pattern of a vinyl polymer unit with a functional group of Formula (I):
wherein the molar ratio of the branched-unit to the linear-unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and -thioC₁-C₆ alkyl, or a combination thereof,
wherein the aryl group in R² is optionally para-substituted;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In a sixth embodiment provided herein is a process of making a polymer comprising:
hydroaminoalkylating polybutadiene polymer post-polymerization in the presence of a group 4 or 5 transition metal catalyst and a secondary amine to form a functionalized polymer, wherein the reaction temperature is 110° C.-165° C.,
producing a polymer comprising
a polybutadiene backbone;
1,2-alkene units,
1,4-alkenes units; and
a branched-unit substituted with a functional group of Formula (I):

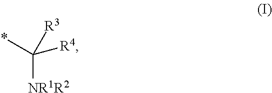

a linear substitution pattern of a vinyl polymer unit with a functional group of Formula (I):
wherein the molar ratio of the branched-unit to the linear-unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and -thioC₁-C₆ alkyl, or a combination thereof,
wherein the aryl group in R² is optionally para-substituted;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In a seventh embodiment provided herein is a process of making a polymer comprising:
functionalizing internal olefins of polybutadiene polymer in the presence of at least 5 mol % of a group 4 or 5 transition metal catalyst and a secondary amine to form a functionalized polymer, wherein the reaction temperature is at least 140° C., wherein the functionalized polymer comprises:
   a polybutadiene backbone;
   1,2-alkene units;
   1,4-alkene units; and
   a 1,4-addition unit substituted with a functional group of Formula (I):

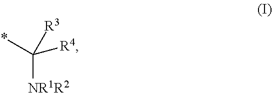

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In an eighth embodiment provided herein is a process of making a polymer comprising:
hydroaminoalkylating a polybutadiene polymer in the presence of at least 10 mol % of Zr-based catalyst and a silyl-protected secondary amine to form a functionalized polymer,
wherein the reaction temperature is at least 140° C., wherein the functionalized polymer comprising:
a polybutadiene backbone;
1,2-alkene units;
1,4-alkenes units; and
a branched-unit substituted with a functional group of Formula (I):

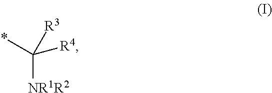

a linear-substitution unit having a functional group of Formula (I): wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In a ninth embodiment provided herein is a process of making a polymer comprising:
hydroaminoalkylating a polybutadiene polymer in the presence of at least 10 mol % of Zr-based catalyst and a silyl-protected secondary amine to form a functionalized polymer,
wherein the reaction temperature is at least 140° C., wherein the functionalized polymer comprising:
   a polybutadiene backbone;
   1,2-alkene units;
   1,4-alkenes units; and
   a branched-unit substituted with a functional group of Formula (I):

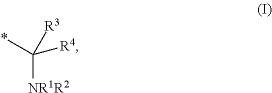

a linear-substitution unit having a functional group of Formula (I): wherein
R¹ is hydrogen, —C₁-C₂₀ alkyl, or —C₆-C₂₀ aryl;
R² is hydrogen, —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, —C₁-C₆ heteroalkyl, C₄₋₁₀ aryl, and C₄ heteroaryl;
an asterisk (*) denotes the point of attachment of the functional group to a carbon atom in the polymeric backbone;
wherein the polymer optionally comprises other unit; and
wherein the units may be ordered or randomly distributed.

### BRIEF DESCRIPTION OF THE FIGURES

FIG. 1A shows ¹H NMR spectrum of Compound 1.

FIG. 1B shows ¹³C{¹H} NMR spectrum of Compound 1.

FIG. 2A shows ¹H NMR spectrum of Compound 2.

FIG. 2B shows ¹³C{¹H} NMR spectrum of Compound 2.

FIG. 3A shows ¹H NMR spectrum of Compound 3.

FIG. 3B shows ¹³C{¹H} NMR spectrum of Compound 3.

FIG. 3C shows ¹H-¹H COSY NMR spectrum of Compound 3.

FIG. 3D shows ¹H-¹³C{¹H} HSQC NMR spectrum of Compound 3.

FIG. 3E shows ¹H-¹³C{¹H} HMBC NMR spectrum of Compound 3.

FIG. 4A shows ¹H NMR spectrum of Compound 4.

FIG. 4B shows ¹³C{¹H} NMR spectrum of Compound 4.

FIG. 5A shows ¹H NMR spectrum of Compound 5.

FIG. 5B shows ¹³C{¹H} NMR spectrum of Compound 5.

FIG. 6A shows ¹H NMR spectrum of Compound 6.

FIG. 6B shows ¹³C{¹H} NMR spectrum of Compound 6.

FIG. 7 shows ¹H NMR spectrum of Compound 7.

FIG. 8 shows stacked ¹H NMR spectrum of Compound 8 prior and post reaction.

FIG. 9A shows ¹H NMR spectrum of Compound 9.

FIG. 9B shows ¹³C{¹H} NMR spectrum of Compound 9.

FIG. 9C shows ¹H-¹H COSY NMR spectrum of Compound 9.

FIG. 9D shows ¹H-¹³C{¹H} HSQC NMR spectrum of Compound 9.

FIG. 9E shows ¹H-¹³C{¹H} HMBC NMR spectrum of Compound 9.

FIG. 10 shows ¹H NMR spectrum (300 MHz, CDCl3) of Compound P6.

FIG. 11 shows ¹H NMR spectrum (300 MHz, CDCl3) of Compound P7.

FIG. 12A shows ¹H NMR spectrum (300 MHz, CDCl3, 298 K) of Compound P9A.

FIG. 12B shows ¹³C NMR (75 MHz, CDCl₃, 298 K) spectrum of P9A.

FIG. 12C shows IR spectrum of P9A.

FIG. 13 shows the overlaid IR spectrum of P10 and P10A.

FIG. 14 shows FT-IR spectrum of Compound P12A.

FIG. 15A shows ¹H NMR (300 MHz, CDCl₃, 298 K) spectrum of P13A.

FIG. 15B shows ¹³C NMR (75 MHz, CDCl₃, 298 K) spectrum of P13A.

FIG. 15C shows IR spectrum of P13A.

FIG. 16 shows ¹H NMR (300 MHz, CDCl3, 298 K) spectrum of Compound P14A.

FIG. 17A shows ¹H NMR (300 MHz, CDCl3, 298 K) spectrum of Compound P15A.

FIG. 17B shows ¹³C{1H} NMR (75 MHz, CDCl3, 298 K) spectrum of Compound P15A.

FIG. 18A shows ¹H NMR (300 MHz, CDCl3, 298 K) spectrum of Compound P16A.

FIG. 18B shows FT-IR spectrum of Compound P16A.

FIG. 19A shows ¹H NMR (300 MHz, CDCl3, 298 K) spectrum of Compound P17A.

FIG. 19B shows ¹³C{1H} NMR (75 MHz, CDCl3, 298 K) spectrum of Compound P17A.

FIG. 20 shows FT-IR spectrum of Compound P18A.

FIG. 21A shows ¹H NMR (300 MHz, CD3OD, 298 K) spectrum of Compound P19A.

FIG. 21B shows ¹³C{1H} NMR (75 MHz, CD3OD, 298 K) spectrum of Compound P19A.

FIG. 21C shows FT-IR spectrum of Compound P19A.

FIG. 22A shows ¹H NMR (300 MHz, CDCL3, 298 K) spectrum of Compound P20A.

FIG. 22B shows ¹³C{1H} NMR (75 MHz, CDCl3, 298 K) spectrum of Compound P20A.

FIG. 22C shows FT-IR spectrum of Compound P20A.

### DETAIL DESCRIPTION

The present disclosure provides hydroaminoalkylation reaction of polybutadiene to give aminated polybutadienes with branched pendant amine functionality. The reaction can be applied with a broad scope of amines and polybutadiene polymer reactants to give products with controlled amine incorporation. The introduction of amines provides polar groups that improve the utility and applicability of these products.

### Definitions

Unless otherwise defined, all terms of art, notations and other scientific terminology used herein are intended to have the meanings commonly understood by those of skill in the art to which this disclosure pertains. In some cases, terms with commonly understood meanings are defined herein for clarity, and/or ready reference. The techniques and procedures described or referenced herein are generally well understood, and are commonly employed using conventional methodologies by those skilled in the art. As appropriate, procedures involving the use of commercially available kits, and reagents are generally carried out in accordance with manufacturer-defined protocols, and conditions unless otherwise noted.

As used herein, the singular forms “a,” “an,” and “the” include the plural referents unless the context clearly indicates otherwise.

The term “about” indicates and encompasses an indicated value, and a range above and below that value. In certain embodiments, the term “about” indicates the designated value±10%, ±5%, or ±1%. In certain embodiments, the term “about” indicates the designated value±one standard deviation of that value. In certain embodiments, for example, logarithmic scales (e.g., pH), the term “about” indicates the designated value±0.3, ±0.2, or ±0.1.

As used herein, the symbol “ [symbol] ” is used to indicate the point of attachment of a repeat unit within a polymeric material to another group within the polymeric material such as another repeat unit or a terminal group.

An asterisk (*) denote the point of attachment of a pendant group to a polymeric chain such as to a carbon atom in the polymeric chain.

The term “polymer” refers to a macrostructure having a number average molecular weight (Mn) of at least 2,000 Daltons, at least 5,000 Daltons, at least 10,000 Daltons, at least 25,000 Daltons, at least 50,000 Daltons, at least 100,000 Daltons, at least 300,000 Daltons, at least 500,000 Daltons, at least 750,000 Daltons, at least 1,000,000 Daltons, or even at least 1,500,000 Daltons. The polymer can be a homopolymer, copolymer, terpolymer, and the like. The polymer can be a random or block copolymer.

The term “polymer backbone” refers to the main continuous chain of carbon-only atoms of the polymer.

When referring to the compounds provided herein, the following terms have the following meanings unless indicated otherwise. Unless defined otherwise, all technical and scientific terms used herein have the same meaning as is commonly understood by one of ordinary skill in the art. In the event that there is a plurality of definitions for a term herein, those in this section prevail unless stated otherwise.

The term “alkyl,” as used herein, unless otherwise specified, refers to a saturated straight, or branched hydrocarbon. In certain embodiments, the alkyl group is a primary, secondary, or tertiary hydrocarbon. In certain embodiments, the alkyl group includes one to ten carbon atoms (i.e., C₁ to C₁₀ alkyl). In certain embodiments, the alkyl is a lower alkyl, for example, C₁₋₆ alkyl, and the like. In certain embodiments, the alkyl group is selected from the group consisting of methyl, ethyl, propyl, isopropyl, butyl, isobutyl, secbutyl, t-butyl, pentyl, isopentyl, neopentyl, hexyl, isohexyl, 3-methylpentyl, 2,2-dimethylbutyl, and 2,3-dimethylbutyl. In certain embodiments, “substituted alkyl” refers to an alkyl substituted with one, two, or three groups independently selected from a halogen (e.g., fluoro (F), chloro (Cl), bromo (Br), or iodo (I)), alkyl, haloalkyl, hydroxyl, amino, alkylamino, alkoxy, aryl, heteroaryl, cycloalkyl, cyano, oxo, alkyne, and heterocycloalkylalkylene. In some embodiments, alkyl is unsubstituted.

The term “alkylene,” as used herein, unless otherwise specified, refers to a divalent alkyl group, as defined herein. “Substituted alkylene” refers to an alkylene group substituted as described herein for alkyl. In some embodiments, alkylene is unsubstituted.

“Alkoxy” and “alkoxyl,” refer to the group —OR″ where R″ is alkyl or cycloalkyl. Alkoxy groups include, in certain embodiments, methoxy, ethoxy, n-propoxy, isopropoxy, n-butoxy, tert-butoxy, sec-butoxy, n-pentoxy, n-hexoxy, 1,2-dimethylbutoxy, and the like.

“Amino” refers to —NH₂.

The term “alkylamino,” as used herein, and unless otherwise specified, refers to the group —NHR″ where R″ is, for example, C₁₋₁₀alkyl, as defined herein. In certain embodiments, alkylamino is C₁₋₆alkylamino.

The term “dialkylamino,” as used herein, and unless otherwise specified, refers to the group —NR″R″ where, each R″ is independently C₁₋₁₀alkyl, as defined herein. In certain embodiments, dialkylamino is di-C₁₋₆alkylamino.

The term “aryl,” as used herein, and unless otherwise specified, refers to phenyl, biphenyl, or naphthyl. The term includes both substituted and unsubstituted moieties. An aryl group can be substituted with any described moiety including, but not limited to, one or more moieties (e.g., in some embodiments one, two, or three moieties) selected from the group consisting of halogen (e.g., fluoro (F), chloro (Cl), bromo (Br), or iodo (I)), alkyl, haloalkyl, hydroxyl, amino, alkylamino, arylamino, alkoxy, aryloxy, nitro, cyano, sulfonic acid, sulfate, phosphonic acid, phosphate, and phosphonate, wherein each moiety is independently either unprotected, or protected as necessary, as would be appreciated by those skilled in the art (e.g., Greene, et al., Protective Groups in Organic Synthesis, John Wiley and Sons, Second Edition, 1991); and wherein the aryl in the arylamino and aryloxy substituents are not further substituted.

The term “arylene,” as used herein, and unless otherwise specified, refers to a divalent aryl group, as defined herein.

The term “haloalkyl” refers to an alkyl group, as defined herein, substituted with one, or more halogen atoms (e.g., in some embodiments one, two, three, four, or five) which are independently selected.

The term “heteroalkyl” refers to an alkyl, as defined herein, in which one or more carbon atoms are replaced by heteroatoms. As used herein, “heteroalkenyl” refers to an alkenyl, as defined herein, in which one, or more carbon atoms are replaced by heteroatoms. As used herein, “heteroalkynyl” refers to an alkynyl, as defined herein, in which one, or more carbon atoms are replaced by heteroatoms. Suitable heteroatoms include, but are not limited to, nitrogen (N), oxygen (O), and sulfur (S) atoms. Heteroalkyl, heteroalkenyl, and heteroalkynyl are optionally substituted. Examples of heteroalkyl moieties include, but are not limited to, aminoalkyl, sulfonylalkyl, and sulfinylalkyl. Examples of heteroalkyl moieties also include, but are not limited to, methylamino, methylsulfonyl, and methylsulfinyl. “Substituted heteroalkyl” refers to heteroalkyl substituted with one, two, or three groups independently selected from halogen (e.g., fluoro (F), chloro (Cl), bromo (Br), or iodo (I)), alkyl, haloalkyl, hydroxyl, amino, alkylamino, and alkoxy. In some embodiments, a heteroalkyl group may comprise one, two, three, or four heteroatoms. Those of skill in the art will recognize that a 4-membered heteroalkyl may generally comprise one, or two heteroatoms, a 5- or 6-membered heteroalkyl may generally comprise one, two, or three heteroatoms, and a 7- to 10-membered heteroalkyl may generally comprise one, two, three, or four heteroatoms.

The terms “halo” or “halogen” or “halide,” by themselves or as part of another substituent, mean, unless otherwise stated, an atom or ion of fluorine, chlorine, bromine, or iodine.

As used herein, an “oxo” refers to ═O.

As used herein, the term “substituted,” whether preceded by the term “optionally” or not, refers generally to the replacement of hydrogen atoms in a given structure with the radical of a specified substituent. Specific substituents are described above in the definitions and below in the description of compounds and examples thereof. Unless otherwise indicated, an optionally substituted group can have a substituent at each substitutable position of the group, and when more than one position in any given structure can be substituted with more than one substituent selected from a specified group, the substituent can be either the same or different at every position. Substituents are not further substituted unless specified explicitly.

As used herein, the term “catalyst”, refers to a chemical compound that accelerates a chemical reaction without itself being affected. “Catalyst” may be used interchangeably with terms such as “pre-catalyst”, “catalyst system”, or “catalytic system”. “Catalyst”, as used herein, includes catalytic intermediates or species formed in situ.

“Group 5 metal” as used herein, refers to the d-electron comprising transition metals listed in the periodic table of the elements as group 5, including transition metals vanadium (V), niobium (Nb), tantalum (Ta), and dubnium (Nb).

“Hydroaminoalkylation”, as used herein, refers to a reaction between a secondary amine containing moiety and an olefin. A catalyst may often be used to promote such reaction.

“Secondary amine”, as used herein, refers to an amine in which the amino group is directly bonded to two C-atoms of any hybridization. The two C-atoms in α-position to the N-atom may be sp³ hybridized.

“Olefin” or “alkene”, as used herein, refers to an unsaturated hydrocarbon containing one or more pairs of C-atoms linked by a double bond.

The term “repeat units of 1,2-alkene” or “1,2 alkene units” refers to a polymer chain with butadiene monomers added in 1,2-addition reaction pathway.

The term “repeat units of 1,4-alkene” or “1,4 alkene units” refers to a polymer chain with butadiene monomers added in 1,4-addition reaction pathway.

The term “branched substitution pattern of a vinyl polymer unit” as used herein refers to the product of an amination reaction pathway wherein an alkene carbon a to the polymer backbone of a vinyl group is aminated to give a branched repeat unit exemplified by Formula III

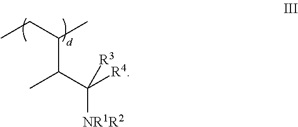

The term “linear substitution pattern of a vinyl polymer unit” as used herein refers to functionalization of the terminal alkene carbon of the vinyl group exemplified by Formula IV

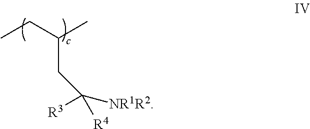

Subscript c characterizes the number of repeats which may be in series or may be randomly distributed throughout the polymer.

The term “branched unit” as used herein refers to alkylated product of hydroaminoalkylation reaction pathway wherein an alkene carbon a to the polymer backbone of a vinyl group is aminated to give a repeat unit exemplified by Formula III

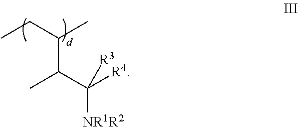

Subscript d characterizes the number of repeats which may be in series or may be randomly distributed throughout the polymer.

The term “linear unit” as used herein refers to alkylated product from functionalization of the terminal alkene carbon of the vinyl group exemplified by Formula IV

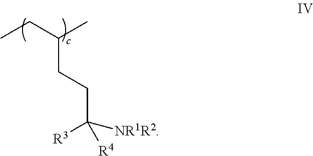

The term “salt thereof,” refers to quaternary ammonium salts of a polymer set forth herein, including, but not limited to hydrochloride and oxalate salts of a quaternary ammonium containing polymer. Salt thereof may include any ionic form of a polymer set forth herein. Salt thereof refers to a quaternary ammonium salts of a polymer set forth herein unless specified explicitly otherwise.

The term PEG as used in “-[PEG]₀₋₁₀” or “-[PEG]₀₋₁₀—(C₂H₄—O)” refers to the polymer chain—poly(ethylene) glycol. This polymer is characterized by repeated ethylene glycol units having the structure (—O—CH₂—CH₂—)ₙ wherein n may range from, and include, 1 to 10; or wherein n may range from, and include, 1 to 50. In some embodiments, a PEG polymer chain is attached to an epoxide.

The term “reduced polybutadiene backbone,” means that residual alkene portions of the main alkyl chain including branched terminal alkenes (also known as the backbone) in a polybutadiene polymer set forth herein is hydrogenated so that alkene bonds are saturated, alkane bonds.

### Manufacture of Polymers

Typical predominant branched unit polymers are prepared from
a polymer comprising:
   hydroaminoalkylating polybutadiene polymer post-polymerization in the presence of at least 5 mol % of group 4 or 5 transition metal catalyst and a secondary amine to form a functionalized polymer, wherein the reaction temperature is from 110-165° C.,
   producing a polymer comprising
a polybutadiene backbone;
1,2-alkene units,
1,4-alkenes units; and
a branched-unit substituted with a functional group of Formula (I):

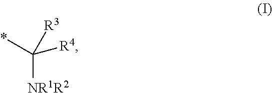

a linear substitution pattern of a vinyl polymer unit with a functional group of Formula (I):
wherein the molar ratio of the branched-unit to the linear-unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof,
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises of other unit; and
wherein the units may be ordered or randomly distributed. In certain embodiments, process is optionally solvent free.

In certain embodiments, the temperature is from 110-165° C. In certain embodiments, the temperature is at least 110° C. In certain embodiments, the temperature is at least 115° C. In certain embodiments, the temperature is at least 120° C. In certain embodiments, the temperature is at least 125° C. In certain embodiments, the temperature is at least 130° C. In certain embodiments, the temperature is at least 135° C. In certain embodiments, the temperature is 140° C. In certain embodiments, the temperature is 145° C. In certain embodiments, the temperature is 150° C. In certain embodiments, the temperature is 155° C.

In certain embodiments, the temperature is from 110-165° C. In certain embodiments, the temperature is 110° C. In certain embodiments, the temperature is 115° C. In certain embodiments, the temperature is 120° C. In certain embodiments, the temperature is 125° C. In certain embodiments, the temperature is 130° C. In certain embodiments, the temperature is 135° C. In certain embodiments, the temperature is 140° C. In certain embodiments, the temperature is 145° C. In certain embodiments, the temperature is 150° C. In certain embodiments, the temperature is 155° C.

In certain embodiments, the catalyst is a Ta-based catalyst. In certain embodiments, the catalyst is Ta(CH₂SiMe₃)₃Cl₂. In certain embodiments, the catalyst is

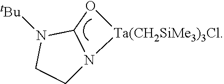

In certain embodiments, the amount of the catalyst is at least 5 mol %. In certain embodiments, the amount of the catalyst is 0.5 mol %. In certain embodiments, the amount of the catalyst is 1 mol %. In certain embodiments, the amount of the catalyst is 2 mol %. In certain embodiments, the amount of the catalyst is 3 mol %. In certain embodiments, the amount of the catalyst is 4 mol %. In certain embodiments, the amount of the catalyst is 5 mol %.

Typical 1,4-addition polymer units are prepared from
a polymer comprising:
functionalizing internal olefins of polybutadiene polymer in the presence of at least 5 mol % of a metal-based catalyst and a secondary amine to form a functionalized polymer, wherein
the reaction temperature is at least 140° C., wherein the functionalized polymer comprises:
a polybutadiene backbone;
1,2-alkene units;
1,4-alkene units; and
a 1,4-addition unit substituted with a functional group of Formula (I):

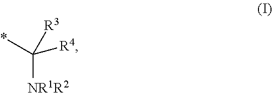

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises of other unit; and
wherein the units may be ordered or randomly distributed. In certain embodiments, process is optionally solvent free.

In certain embodiments, substituted aminated polybutadiene are prepared from hydroaminoalkylating a polybutadiene polymer in the presence of a Zr-based catalyst and a silyl-protected secondary amine to form a functionalized polymer, wherein the reaction temperature is at least 140° C., wherein the functionalized polymer comprising:
a polybutadiene backbone;
1,2-alkene units;
1,4-alkenes units; and
a branched-unit substituted with a functional group of Formula (I):

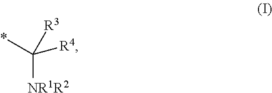

and
a linear-substitution unit having a functional group of Formula (I): wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises of other unit; and
wherein the units may be ordered or randomly distributed. In certain embodiments, process is optionally solvent free. In certain embodiments, the amine is N-benzylsilylamine.

In some other embodiments, substituted aminated polybutadiene are prepared from
hydroaminoalkylating a polybutadiene polymer in the presence of a Zr-based catalyst and a silyl-protected secondary amine to form a functionalized polymer, wherein the reaction temperature is at least 140° C., wherein the functionalized polymer comprising:
   a polybutadiene backbone;
   1,2-alkene units;
   1,4-alkenes units; and
   a branched-unit substituted with a functional group of Formula (I):

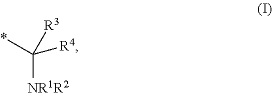

and
a linear-substitution unit having a functional group of Formula (I): wherein
R¹ is hydrogen, —C₁-C₂₀ alkyl, or —C₆-C₂₀ aryl;
R² is hydrogen, —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, —C₁-C₆ heteroalkyl, C₄₋₁₀ aryl, and C₄ heteroaryl;
an asterisk (*) denotes the point of attachment of the functional group to a carbon atom in the polymeric backbone;
wherein the polymer optionally comprises of other unit; and
wherein the units may be ordered or randomly distributed. In certain embodiments, process is optionally solvent free. In certain embodiments, the amine is N-benzylsilylamine.

### Methods of Use

In certain embodiments, the aminated materials disclosed herein may have application in adhesive and coating formulations. In certain embodiments, the aminated materials disclosed herein may have application as additives to materials such as rubber, plastics, composite materials, waxes etc. In certain embodiments, the aminated materials disclosed herein may have application as lubricants, polymer membranes and filters. In certain embodiments, the aminated materials disclosed herein may have application as polymer compatibilizers. In certain embodiments, the aminated materials disclosed herein may have application as drug-delivery agents. In certain embodiments, the aminated materials disclosed herein may have application as rheology modifiers, fuel additives, or dispersing agents.

### Compounds

In one embodiment provided herein is a polymer comprising:
a polybutadiene backbone;
1,2-alkene units;
1,4-alkenes units; and
a branched-substitution unit having a functional group of Formula (I):

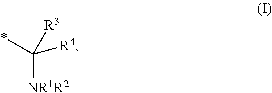

a linear-substitution unit having a functional group of Formula (I). In certain embodiments
the molar ratio of the branched-unit to the linear-unit is 6:1 or greater.

In Formula (I), R¹ is hydrogen, —C₁-C₂₀ alkyl, or —C₆-C₂₀ aryl; R² is —C₁-C₂₀ alkyl or —C₆-C₂₀ aryl; or R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof; R³ and R⁴ are, independently in each instance selected from hydrogen, C₁-C₆ alkyl, and C₁-C₆ heteroalkyl; an asterisk (*) denotes the point of attachment of the functional group to a carbon atom in the polymeric backbone. In certain embodiments, the polymer optionally comprises other unit. In certain embodiments the units may be ordered in series, in blocks, or randomly distributed.

In certain embodiments, R¹ is hydrogen. In certain embodiments, R¹ is —C₁-C₂₀ alkyl. In certain embodiments, R¹ is —C₆-C₂₀ aryl.

In certain embodiments, R² is —C₁-C₂₀ alkyl. In certain embodiments, R² is —C₆-C₂₀ aryl. In certain embodiments, R¹ and R² together with the nitrogen to which they are both attached form a —C₃-C₂₀ heterocyclic ring having 0 to 2 additional heteroatoms selected from nitrogen and oxygen In certain embodiments, R¹ and R² are each independently optionally substituted with one to six groups selected from —F, —C₁, —I, —Br, —OCH₃, —OCF₃, and —C₁-C₆ thioalkyl, or a combination thereof. In certain embodiments, the aryl group in R² is optionally para-substituted.

In certain embodiments, R³ and R⁴ are, independently in each instance selected from -hydrogen, —C₁-C₆ alkyl, and —C₁-C₆ heteroalkyl. In certain embodiments, R³ is hydrogen. In certain embodiments R³ is —C₁-C₆ alkyl. In certain embodiments R³ is —C₁-C₆ heteroalkyl. In certain embodiments, R⁴ is —H. In certain embodiments R⁴ is —C₁-C₆ alkyl. In certain embodiments R⁴ is —C₁-C₆ heteroalkyl.

In certain embodiments, the molar ratio of the branched-unit to the linear-unit product is 6:1 or greater. In certain embodiments, the ratio of the branched-unit to the linear-unit product is 6:1. In certain embodiments, the ratio of the branched-unit to the linear-unit product is 9:1. In certain embodiments, the molar ratio of the branched-unit to the linear-unit product can be varied by turning the reaction conditions. In certain embodiments, the amounts of 1,2-alkene units and 1,4-alkene units may be equal or variable. In certain embodiments, the polymer comprises 92% 1,4-alkene units and 8% 1,2-alkene units.

In certain embodiments, the polymer comprises of at least 60% branched-substitution units relative to linear-substitution units. In certain embodiments, the polymer comprises of at least 90% branched-substitution units relative to linear-substitution units.

In certain embodiments, the polymer optionally comprises of other unit. In certain embodiments, the other unit comprises styrene units optionally substituted with alkyl, substituted alkyl, heteroalkyl, substituted heteroalkyl, styrene, substituted styrene, or mixtures. In certain embodiments, the other unit comprises styrene units optionally substituted with alkyl. In certain embodiments, the other unit comprises alkyl. In certain embodiments, the other unit comprises heteroalkyl. In certain embodiments, the other unit comprises substituted heteroalkyl. In certain embodiments, the other unit comprises styrene. In certain embodiments, the other unit comprises substituted styrene. In certain embodiments, the monomer units are connected in a head-to-head fashion. In certain embodiments, the monomer units are connected in a head to tail fashion. In certain embodiments, the monomer units are connected in a tail-to-tail fashion.

In certain embodiments the units may be ordered in series, in blocks, or randomly distributed.

In one embodiment provided herein is a polymer of Formula (II)

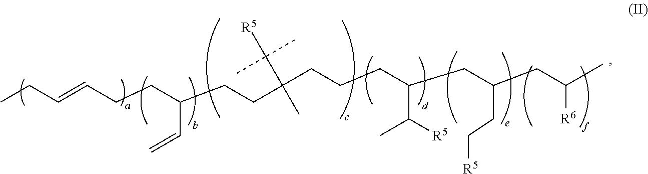

or a fragment thereof.

In one embodiment provided herein is a polymer comprising a fragment of the polymer of Formula (II)

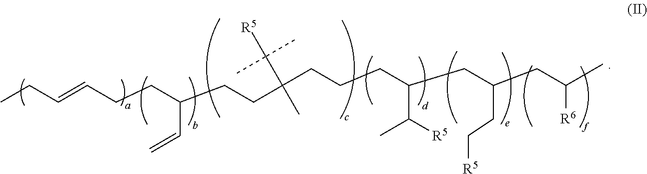

In some examples, the fragment forms a polymer with isoprene units. In certain examples, these polymers are formed by copolymerizing butadiene with isoprene and adding an amine functional group, for example a functional group of Formula (I), to the polymer(s) formed by copolymerizing butadiene with isoprene.

In Formula (II), R⁵ is optionally a compound of Formula (I):

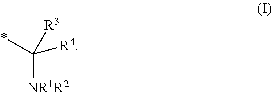

In certain embodiments, when R⁵ is present on the c unit, the dashed line indicates a single bond. In certain embodiments, when R⁵ is absent on the c unit, the dashed line indicates a double bond.

In Formula (I), R¹ is hydrogen, —C₁-C₂₀ alkyl, or —C₆-C₂₀ aryl; R² is —C₁-C₂₀ alkyl or —C₆-C₂₀ aryl; or R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof; R³ and R⁴ are, independently in each instance selected from H, C₁-C₆ alkyl, and C₁-C₆ heteroalkyl; an asterisk (*) denotes the point of attachment of the functional group to a carbon atom in the polymeric backbone.

In certain embodiments, R¹ is hydrogen. In certain embodiments, R¹ is —C₁-C₂₀ alkyl. In certain embodiments, R¹ is —C₆-C₂₀ aryl.

In certain embodiments, R² is —C₁-C₂₀ alkyl. In certain embodiments, R² is —C₆-C₂₀ aryl. In certain embodiments, R¹ and R² together with the nitrogen to which they are both attached form a —C₃-C₂₀ heterocyclic ring having 0 to 2 additional heteroatoms selected from nitrogen and oxygen In certain embodiments, R¹ and R² are each independently optionally substituted with one to six groups selected from —F, —C₁, —I, —Br, —OCH₃, —OCF₃, and —C₁-C₆ thioalkyl, or a combination thereof. In certain embodiments, the aryl group in R² is optionally para-substituted.

In embodiments, R³ and R⁴ are, independently in each instance selected from -hydrogen, —C₁-C₆ alkyl, and —C₁-C₆ heteroalkyl. In certain embodiments, R³ is hydrogen. In certain embodiments, R³ is —C₁-C₆ alkyl. In certain embodiments, R³ is —C₁-C₆ heteroalkyl. In certain embodiments, R⁴ is —H. In certain embodiments, R⁴ is —C₁-C₆ alkyl. In certain embodiments, R⁴ is —C₁-C₆ heteroalkyl.

In Formula (II), R⁶ is hydrogen, —C₁-C₂₀ alkyl, —C₆-C₂₀ aryl, —C₁₋₆alkyl-C₁-C₂₀ alkyl, —C₁₋₆alkyl-C₆-C₂₀ aryl, —C₁₋₆heteroalkyl-C₁-C₂₀ alkyl, or —C₁₋₆heteroalkyl-C₆-C₂₀ aryl. In certain embodiments, R⁶ is hydrogen. In certain embodiments, R⁶ is-C₁-C₂₀ alkyl. In certain embodiments, R⁶ is-C₆-C₂₀ aryl. In certain embodiments, R⁶ is-C₁₋₆alkyl-C₁-C₂₀ alkyl. In certain embodiments, R⁶ is-C₁₋₆heteroalkyl-C₁-C₂₀ alkyl. In certain embodiments, R⁶ is-C₁-C₆heteroalkyl-C₆-C₂₀ aryl.

In Formula (II), a, b, c, d, e, and f are independently at each occurrence from 0 to 100,000. In certain embodiments, the ratio of d:e is 6:1 or greater. In certain embodiments, the ratio of d:e is >9:1. In certain embodiments, the blocks may be ordered or randomly distributed. In certain embodiments, the ratio of d:c can be varied by turning the reaction conditions. In certain embodiments, in the starting polymer where “a” is much greater than “b”, gives more c unit relative to the d unit. In certain embodiments, the d block typically forms first, and if the reaction is halted, then the ratio of d is >>c. In certain embodiments, if the reaction has sufficient time and amine loading, more and more “a” gets reacted, resulting in ratios of d:c that are not always d>>>c. In certain embodiments, the ratio of a:b (blocks derived from 1,4 and 1,2 addition of butadiene in the polymer respectively) in the starting polymer reactant can also vary.

In Formula (II), the units may be ordered or randomly distributed. In certain embodiments, the units are ordered. In certain embodiments, the units are randomly distributed.

In certain embodiments of Formula (II), the ratio of a:b is 0.1, 0.5, 1, 1.5, 2, or 10. In certain embodiments, the ratio of d:e is 6:1.

In certain embodiments, the compound of Formula (II) has a structure of Formula (IIa):

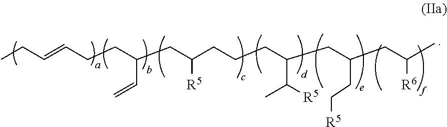

In certain embodiments, the compound of Formula (II) has a structure of Formula (IIb):

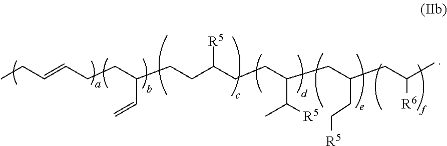

In certain embodiments, the compound of Formula (II) has a structure of Formula (IIc):

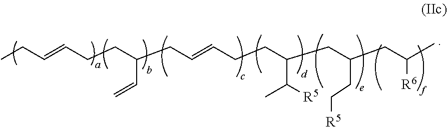

In certain embodiments, the compound of Formula (II) has a structure of Formula (IId):

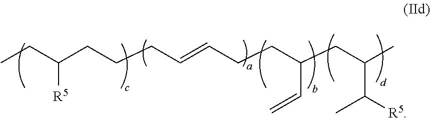

In certain embodiments, the compound of Formula (II) has a structure of Formula (IIe):

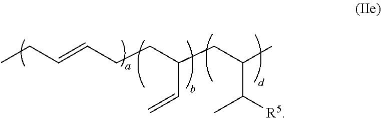

In certain embodiments of Formula (IIa), (IIb), (IIc), (IId), or (IIe), R⁵ is optionally a compound of Formula (I):

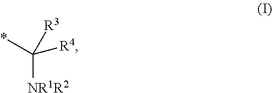

In Formula (I), R¹ is hydrogen, —C₁-C₂₀ alkyl, or —C₆-C₂₀ aryl; R² is —C₁-C₂₀ alkyl or —C₆-C₂₀ aryl; or R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof, wherein the aryl group in R² is optionally para-substituted; R³ and R⁴ are, independently in each instance selected from H, C₁-C₆ alkyl, and C₁-C₆ heteroalkyl; an asterisk (*) denotes the point of attachment of the functional group to a carbon atom in the polymeric backbone.

In certain embodiments, R¹ is hydrogen. In certain embodiments, R¹ is —C₁-C₂₀ alkyl. In certain embodiments, R¹ is —C₆-C₂₀ aryl.

In certain embodiments, R² is —C₁-C₂₀ alkyl. In certain embodiments, R² is —C₆-C₂₀ aryl. In certain embodiments, R¹ and R² together with the nitrogen to which they are both attached form a —C₃-C₂₀ heterocyclic ring having 0 to 2 additional heteroatoms selected from nitrogen and oxygen In certain embodiments, R¹ and R² are each independently optionally substituted with one to six groups selected from —F, —C₁, —I, —Br, —OCH₃, —OCF₃, and —C₁-C₆ thioalkyl, or a combination thereof. In certain embodiments, the aryl group in R² is optionally para-substituted.

In embodiments, R³ and R⁴ are, independently in each instance selected from -hydrogen, —C₁-C₆ alkyl, and —C₁-C₆ heteroalkyl. In certain embodiments, R³ is hydrogen. In certain embodiments, R³ is —C₁-C₆ alkyl. In certain embodiments, R³ is —C₁-C₆ heteroalkyl. In certain embodiments, R⁴ is —H. In certain embodiments, R⁴ is —C₁-C₆ alkyl. In certain embodiments, R⁴ is —C₁-C₆ heteroalkyl.

In certain embodiments of Formula (IIa), (IIb), or (IIc), R⁶ is hydrogen, —C₁-C₂₀ alkyl, —C₆-C₂₀ aryl, —C₁₋₆alkyl-C₁-C₂₀ alkyl, —C₁-6alkyl-C₆-C₂₀ aryl, —C₁₋₆heteroalkyl-C₁-C₂₀ alkyl, or —C₁₋₆heteroalkyl-C₆-C₂₀ aryl. In certain embodiments, R⁶ is hydrogen. In certain embodiments, R⁶ is-C₁-C₂₀ alkyl. In certain embodiments, R⁶ is-C₆-C₂₀ aryl. In certain embodiments, R⁶ is-C₁₋₆alkyl-C₁-C₂₀ alkyl. In certain embodiments, R⁶ is-C₁₋₆heteroalkyl-C₁-C₂₀ alkyl. In certain embodiments, R⁶ is-C₁₋₆heteroalkyl-C₆-C₂₀ aryl.

In certain embodiments of Formula (IIa), (IIb), (IIc), (IId), or (IIe), a, b, c, d, e, and f are independently at each occurrence from 0 to 100,000. In certain embodiments, the ratio of d:e is 6:1 or greater. In certain embodiments, the ratio of d:e is >9:1. In certain embodiments, the blocks may be ordered or randomly distributed. In certain embodiments, the ratio of d:c can be varied by turning the reaction conditions. In certain embodiments, in the starting polymer where “a” is much greater than “b”, gives more c unit relative to the d unit. In certain embodiments, the d block typically forms first, and if the reaction is halted, then the ratio of d is >>c. In certain embodiments, if the reaction has sufficient time and amine loading, more and more “a” gets reacted, resulting in ratios of d:c that are not always d>>>c. In certain embodiments, the ratio of a:b (blocks derived from 1,4 and 1,2 addition of butadiene in the polymer respectively) in the starting polymer reactant can also vary.

In one embodiment provided herein is polymer comprising:
a polybutadiene backbone;
1,2-alkene units,
1,4-alkenes units; and
a 1,4-addition unit substituted with a functional group of Formula (I):

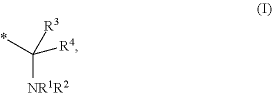

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

In another embodiment provided herein is polymer comprising:
a polybutadiene backbone;
a unit comprising repeat units of 1,2-alkene,
a unit comprising repeat units of 1,4-alkenes; and
a branched-unit substituted with a functional group of Formula (I):

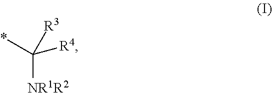

a linear-substitution unit having a functional group of Formula (I). In certain embodiments, the polymer optionally comprises other unit. In certain embodiments, the units may be ordered or randomly distributed.

In Formula (I), R¹ is hydrogen, —C₁-C₂₀ alkyl, or —C₆-C₂₀ aryl; R² is —C₁-C₂₀ alkyl or —C₆-C₂₀ aryl; or R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof; R³ and R⁴ are, independently in each instance selected from hydrogen, C₁-C₆ alkyl, and C₁-C₆ heteroalkyl; an asterisk (*) denotes the point of attachment of the functional group to a carbon atom in the polymeric backbone.

In certain embodiments, R¹ is hydrogen. In certain embodiments, R¹ is —C₁-C₂₀ alkyl. In certain embodiments, R¹ is —C₆-C₂₀ aryl.

In certain embodiments, R² is —C₁-C₂₀ alkyl. In certain embodiments, R² is —C₆-C₂₀ aryl. In certain embodiments, R¹ and R² together with the nitrogen to which they are both attached form a —C₃-C₂₀ heterocyclic ring having 0 to 2 additional heteroatoms selected from nitrogen and oxygen In certain embodiments, R¹ and R² are each independently optionally substituted with one to six groups selected from —F, —C₁, —I, —Br, —OCH₃, —OCF₃, and —C₁-C₆ thioalkyl, or a combination thereof. In certain embodiments, the aryl group in R² is optionally para-substituted.

In certain embodiments, R³ and R⁴ are, independently in each instance selected from -hydrogen, —C₁-C₆ alkyl, and —C₁-C₆ heteroalkyl. In certain embodiments, R³ is hydrogen. In certain embodiments, R³ is —C₁-C₆ alkyl. In certain embodiments, R³ is —C₁-C₆ heteroalkyl. In certain embodiments, R⁴ is —H. In certain embodiments, R⁴ is —C₁-C₆ alkyl. In certain embodiments, R⁴ is —C₁-C₆ heteroalkyl.

In certain embodiments, the compound is

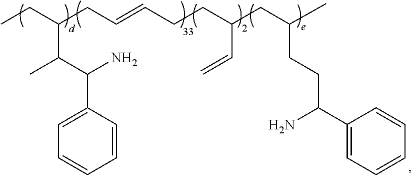

wherein the sum of subscnipt d and e is 9.

In certain embodiments, provided herein are compounds of the following Table:

| Com- | |
|---|---|
| pound | |
| No. | Structure |
| 1 | 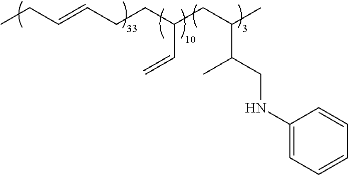 |
| 2 | 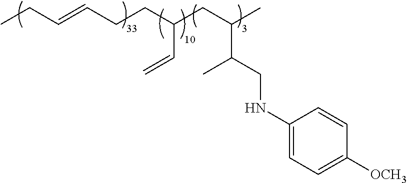 |
| 3 | 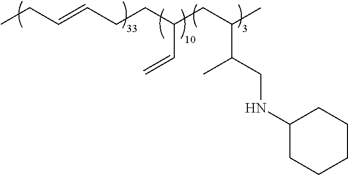 |
| 4 | 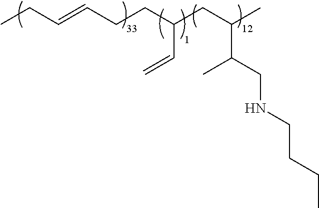 |
| 5 | 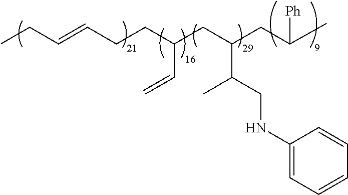 |
| 6 | 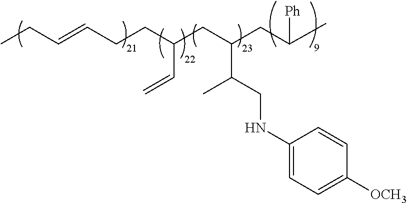 |
| 7 | 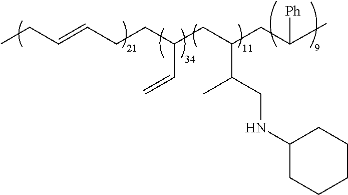 |
| 8 | 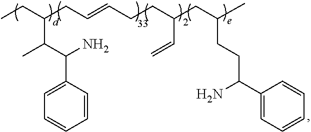 |
| | wherein the sum |
| | of subscript d and e is 9; and |
| 9 | 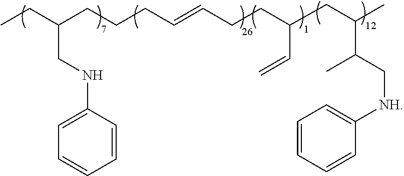 |

### Embodiments

Embodiment one: a polymer comprising:
a polybutadiene backbone;
1,2-alkene units;
1,4-alkenes units; and
a branched-substitution unit having a functional group of Formula (I):

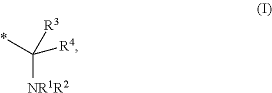

a linear-substitution unit having a functional group of Formula (I):
wherein the molar ratio of the branched-unit to the linear-unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises of other units; and
wherein the units may be ordered in series, in blocks, or randomly distributed.

Embodiment two: The polymer of embodiment 1, wherein the product contains at least 60% branched-substitution units relative to linear-substitution units.

Embodiment three: The polymer of any one of embodiments 1-2, wherein the amounts of 1,2-alkene units and 1,4-alkenes units may be equal or variable.

Embodiment four: The polymer of any one of embodiments 1-3, comprising 92% 1,4-alkene units and 8% 1,2-alkene units.

Embodiment five: The polymer of any one of embodiments 1-4, wherein the other unit comprises styrene-units optionally substituted with alkyl, substituted alkyl, heteroalkyl, substituted heteroalkyl, styrene, substituted styrene, or mixtures thereof.

Embodiment six: The polymer of embodiment 5, wherein the other unit comprises styrene units.

Embodiment seven: The polymer of embodiment 1, wherein the other unit is an isoprene unit.

Embodiment eight: The polymer of any one of embodiments 1-7, wherein the aryl group in R² is optionally para-substituted.

Embodiment nine: A polymer of Formula (II)

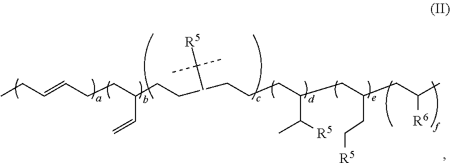

or a fragment thereof, wherein
R⁵ is present or absent;
when R⁵ is present on the c unit, the dashed line indicates a single bond, when R⁵ is absent on the c unit, the dashed line indicates a double bond;
R⁵ is optionally a compound of Formula (I)

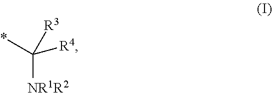

wherein
R¹ is —C₁-C₂₀ alkyl or —C₆-C₂₀ aryl; or
R² is hydrogen, —C₁-C₂₀ alkyl, or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R³ and R⁴ are each independently optionally substituted with one to six groups selected from —F, —C₁, —I, —Br, —OCH₃, —OCF₃, and —C₁-C₆ thioalkyl, or a combination thereof,
wherein the aryl group in R² is optionally para-substituted;
R³ and R⁴ are, independently in each instance selected from hydrogen, —C₁-C₆ alkyl, and —C₁-C₆ heteroalkyl;
R⁶ is hydrogen, —C₁-C₂₀ alkyl, —C₆-C₂₀ aryl, —C₁-6alkyl-C₁-C₂₀ alkyl, —C₁-6alkyl-C₆-C₂₀ aryl, —C₁₋₆heteroalkyl-C₁-C₂₀ alkyl, or —C₁₋₆heteroalkyl-C₆-C₂₀ aryl; and
   a, b, c, d, e, and f are independently at each occurrence an integer from 0 to 100,000; wherein
   the ratio of d:e is 6:1 or greater, wherein the units may be ordered or randomly distributed.

Embodiment ten: The polymer of embodiment 9, wherein the ratio of a:b is 0.1, 0.5, 1, 1.5, 2, or 10.

Embodiment eleven: The polymer of any one of embodiments 9 and 10, wherein the ratio of d:e is 6:1.

Embodiment twelve: The polymer of any one of embodiments 9-11, wherein the aryl group in R² is optionally para-substituted.

Embodiment thirteen: The polymer of Formula (II) having the structure of Formula (IIa)

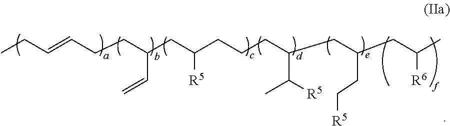

Embodiment fourteen: The polymer of Formula (II) having the structure of Formula (IIb)

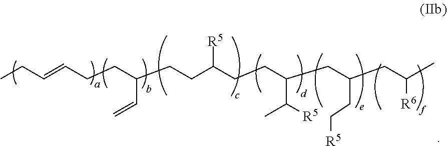

Embodiment fifteen: The polymer of Formula (II) having the structure of Formula (IIc)

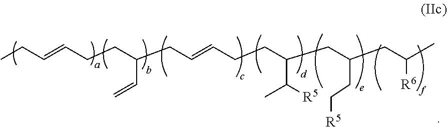

Embodiment sixteen: The polymer of Formula (II) having the structure of Formula (IId)

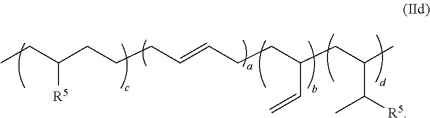

Embodiment seventeen: The polymer of Formula (II) having the structure of Formula (IIe)

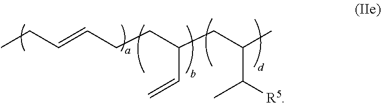

Embodiment eighteen: The polymer of any one of embodiments 1 and 9 selected from the following compounds:

| Com- | |
|---|---|
| pound | |
| No. | Structure |
| 1 | 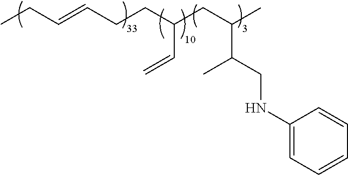 |
| 2 | 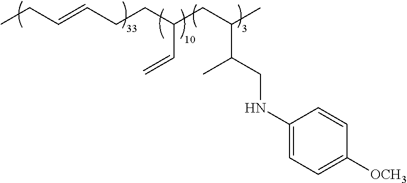 |
| 3 | 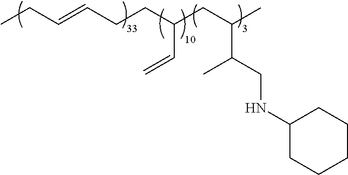 |
| 4 | 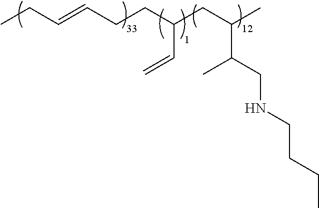 |
| 5 | 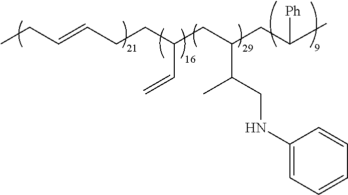 |
| 6 | 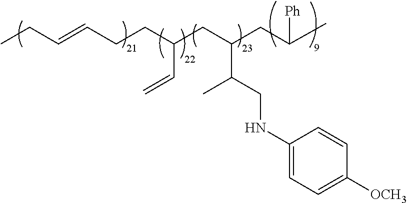 |
| 7 | 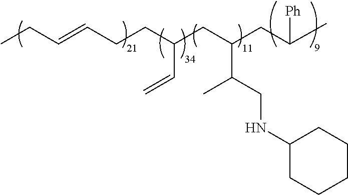 |
| 8 | 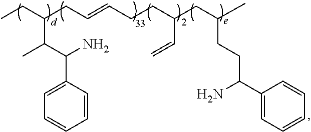 |
| | wherein the sum of subscript d and e is 9; and |
| 9 | 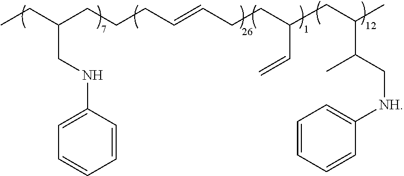 |

Embodiment nineteen: A polymer comprising:
a polybutadiene backbone;
1,2-alkene units,
1,4-alkenes units; and
a 1,4-addition unit substituted with a functional group of Formula (I):

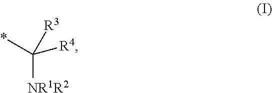

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
wherein the units may be ordered or randomly distributed.

Embodiment twenty: A polymer comprising:
a polybutadiene backbone;
a unit comprising repeat units of 1,2-alkene,
a unit comprising repeat units of 1,4-alkenes; and
a branched-unit substituted with a functional group of Formula (I):

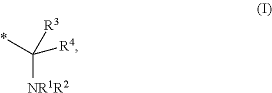

a linear-substitution unit having a functional group of Formula (I): wherein
   R¹ is hydrogen, —C₁-C₂₀ alkyl, or —C₆-C₂₀ aryl;
   R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other unit; and
   wherein the units may be ordered or randomly distributed.

Embodiment twenty-one: The polymer of embodiment 20 having the following structure:

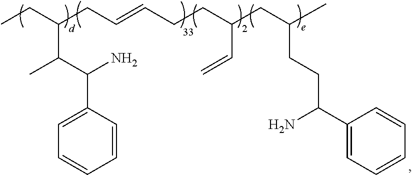

wherein the sum of subscript d and e is 9.

Embodiment twenty-two: A process for making a polymer comprising:
hydroaminoalkylating a polybutadiene polymer post-polymerization in the presence of at least 5 mol % of group 4 or 5 transition metal catalyst and a secondary amine to form a functionalized polymer, wherein the reaction temperature is 110° C.-165° C.,
producing a polymer comprising:
a polybutadiene backbone;
1,2-alkene units,
1,4-alkenes units; and
a branched-unit substituted with a functional group of Formula (I):

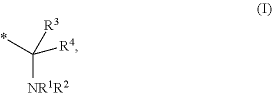

a linear-unit substituted with a functional group of Formula (I):
   wherein the molar ratio of the branched-unit to the linear-unit is 6:1 or greater;
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other units; and
wherein the units may be ordered or randomly distributed.

Embodiment twenty-three: The process of embodiment 22, wherein the catalyst is a Ta-based catalyst.

Embodiment twenty-four: A process for making a polymer comprising:

functionalizing internal olefins of a polybutadiene polymer in the presence of at least 5 mol % of a group 4 or 5 transition metal catalyst and a secondary amine to form a functionalized polymer, wherein the reaction temperature is at least 140° C., wherein the functionalized polymer comprises:
a polybutadiene backbone;
1,2-alkene units,
1,4-alkenes units; and
a 1,4-addition unit substituted with a functional group of Formula (I):

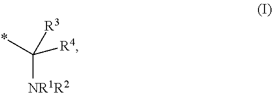

wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other units; and
wherein the units may be ordered or randomly distributed.

Embodiment twenty-five: A process for making a polymer comprising:
hydroaminoalkylating a polybutadiene polymer in the presence of a Zr-based catalyst and a silyl-protected secondary amine to form a functionalized polymer, wherein the reaction temperature is at least 140° C., wherein the functionalized polymer comprising:
   a polybutadiene backbone;
   1,2-alkene units;
   1,4-alkenes units; and
   a branched-unit substituted with a functional group of Formula (I):

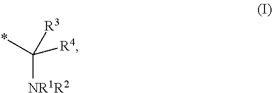

a linear-substitution unit having a functional group of Formula (I): wherein
R¹ is hydrogen, —C₁-C₂₀ alkyl, or —C₆-C₂₀ aryl;
R² is —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises other units; and
wherein the units may be ordered or randomly distributed.

In some other embodiments, set forth herein is a process for making a polymer comprising:

hydroaminoalkylating a polybutadiene polymer in the presence of a Zr-based catalyst and a silyl-protected secondary amine to form a functionalized polymer, wherein the reaction temperature is at least 140° C., wherein the functionalized polymer comprising:
a polybutadiene backbone;
1,2-alkene units;
1,4-alkenes units; and
a branched-unit substituted with a functional group of Formula (I):

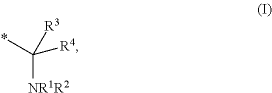

a linear-substitution unit having a functional group of Formula (I): wherein
R¹ is hydrogen, —C₁-C₂₀ alkyl, or —C₆-C₂₀ aryl;
R² is hydrogen, —C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, —C₁-C₆ heteroalkyl, —C₄₋₁₀ aryl, or -C₄ heteroaryl;
an asterisk (*) denotes the point of attachment of the functional group to a carbon atom in the polymeric backbone;
wherein the polymer optionally comprises other units; and
wherein the units may be ordered or randomly distributed.

Embodiment twenty-six: The process of embodiment 25, wherein the amine is N-benzyl silylamine.

Embodiment twenty-seven: A polymer made by the process of any one of embodiments 22-26.

Embodiment twenty-eight: A polymer made by the process of any one of embodiments 22-26, wherein the process is optionally solvent free.

Embodiment twenty-nine: A polymer comprising:
a polybutadiene backbone;
1,2-alkene units;
1,4-alkene units; and
a branched-substitution unit having a functional group of Formula (I) or a salt thereof:

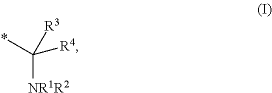

a linear-substitution unit having a functional group of Formula (I) or a salt thereof:
wherein the molar ratio of the branched-substitution unit to the linear-substitution unit is 6:1 or greater;
R¹ is hydrogen, —C₁-C₂₀ alkyl, or —C₆-C₂₀ aryl;
R² is -L-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl; L¹ is, independently in each instance, a bond, C₁-C₃ alkylene, —(C═O)—C₂-C₄ alkylene, or —(C═O)(NR³)—C₁-C₃ alkylene;
an asterisk (*) denotes the point of attachment of the functional group to a carbon atom in the polymeric backbone;
wherein the polymer optionally comprises one or more other units; and
wherein the units may be ordered in series, in blocks, or randomly distributed.

Embodiment thirty: The polymer of embodiment 29, wherein L¹ is a bond.

Embodiment thirty-one: The polymer of embodiment 29 or 30, wherein R² is —C₁-C₂₀alkyl or —C₆-C₂₀ aryl.

Embodiment thirty-two: The polymer of any one of embodiments 29-31, wherein the polymer contains at least 60% branched-substitution units relative to linear-substitution units.

Embodiment thirty-three: The polymer of any one of embodiments 29-32, wherein the amounts of 1,2-alkene units and 1,4-alkenes units may be equal or variable.6. The polymer of any one of embodiments 1-5, comprising 92% 1,4-alkene units and 8% 1,2-alkene units.

Embodiment thirty-four: The polymer of any one of embodiments 29-33, wherein the one or more other units comprise styrene units optionally substituted with alkyl, substituted alkyl, heteroalkyl, substituted heteroalkyl, styrene, substituted styrene, or mixtures thereof.

Embodiment thirty-five: The polymer of embodiment 34, wherein the one or more other units comprise styrene units.

Embodiment thirty-six: The polymer of any one of embodiments 29-35, wherein the one or more other units is an isoprene unit.

Embodiment thirty-seven: The polymer of any one of embodiments 29-36, wherein the aryl group in R² is para-substituted.

Embodiment thirty-eight: A polymer of Formula (II)

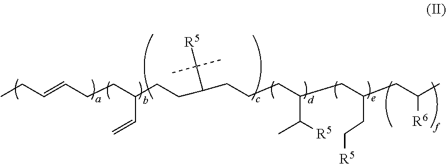

or a fragment thereof, wherein
R⁵ is present or absent;
when R⁵ is present on the c unit, the dashed line indicates a single bond, and when R⁵ is absent on the c unit, the dashed line indicates a double bond;
R⁵ is a compound of Formula (I) or a salt thereof:

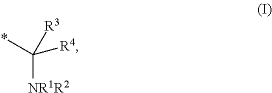

wherein
R¹ is —C₁-C₂₀ alkyl or —C₆-C₂₀ aryl; or
R² is hydrogen, -L¹-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R³ and R⁴ are each independently optionally substituted with one to six groups selected from —F, —C₁, —I, —Br, —OCH₃, —OCF₃, and —C₁-C₆ thioalkyl, or a combination thereof,
wherein the aryl group in R² is optionally para-substituted;
R³ and R⁴ are, independently in each instance selected from hydrogen, —C₁-C₆ alkyl, and —C₁-C₆ heteroalkyl;
L¹ is, independently in each instance, a bond, C₁-C₃ alkylene, —(C═O)—C₂-C₄ alkylene, or —(C═O)(NR³)—C₁-C₃ alkylene;
R⁶ is hydrogen, —C₁-C₂₀ alkyl, —C₆-C₂₀ aryl, —C₁₋₆alkyl-C₁-C₂₀ alkyl, —C₁₋₆alkyl-C₆-C₂₀ aryl, —C₁₋₆heteroalkyl-C₁-C₂₀ alkyl, or —C₁₋₆heteroalkyl-C₆-C₂M aryl; and
   a, b, c, d, e, and f are independently at each occurrence an integer from 0 to 100,000; wherein
   the ratio of d:e is 6:1 or greater, wherein the units may be ordered or randomly distributed.

Embodiment thirty-nine: The polymer of embodiment 38, wherein L¹ is a bond.

Embodiment forty: The polymer of embodiment 38 or 39, wherein R² is —C₁-C₂₀ alkyl or —C₆-C₂₀ aryl.

Embodiment forty-one: The polymer of any one of embodiments 38-40, wherein the ratio of a:b is 0.1, 0.5, 1, 1.5, 2, or 10.

Embodiment forty-two: The polymer of any one of embodiments 38-41, wherein the ratio of d:e is 6:1.

Embodiment forty-three: The polymer of any one of embodiments 38-42, wherein
the aryl group in R² is para-substituted.

Embodiment forty-four: The polymer of any one of embodiments 38-43, wherein Formula (II) has a structure of Formula (IIa)

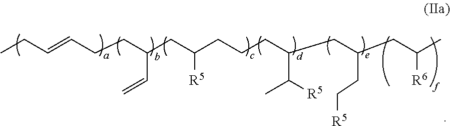

Embodiment forty-five: The polymer of any one of embodiments 38-44, wherein Formula (II) has a structure of Formula (IIb)

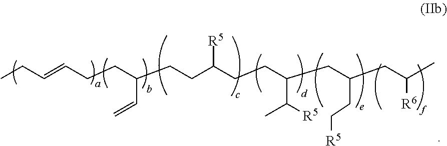

Embodiment forty-six: The polymer of any one of embodiments 38-45, wherein Formula (II) has a structure of Formula (IIc)

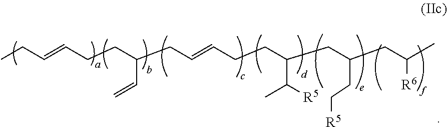

Embodiment forty-seven: The polymer of any one of embodiments 38-46, wherein Formula (II) has a structure of Formula (IId)

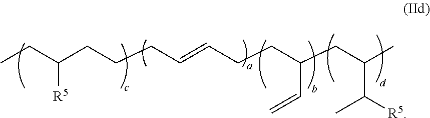

Embodiment forty-eight: The polymer of any one of embodiments 38-48, wherein Formula (II) has a structure of Formula (IIe)

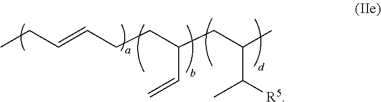

Embodiment forty-nine: The polymer of any one of embodiments 38 and 48, wherein the polymer is selected from the following compounds:

| Com- | |
|---|---|
| pound | |
| No. | Structure |
| 1 | 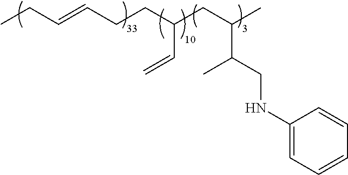 |
| 2 | 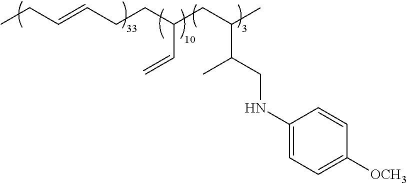 |
| 3 | 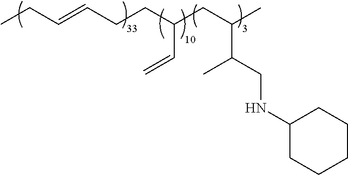 |
| 4 | 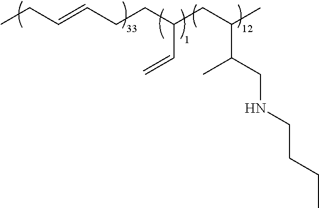 |
| 5 | 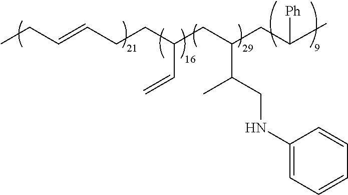 |
| 6 | 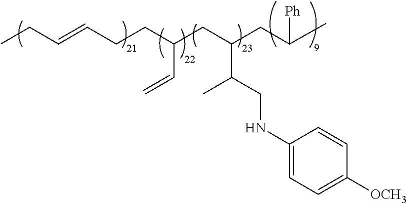 |
| 7 | 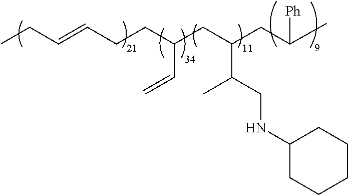 |
| 8 | 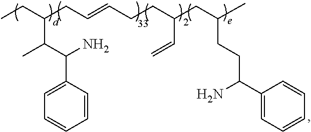 |
| | wherein the sum of subscript d and e is 9; and |
| 9 | 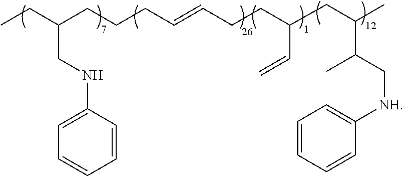 |

Embodiment fifty: A polymer comprising:
a polybutadiene backbone;
1,2-alkene units,
1,4-alkene units; and
a 1,4-addition unit substituted with a functional group of Formula (I) or a salt thereof:

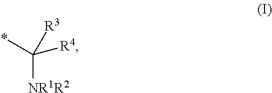

wherein
R¹ is hydrogen, —C₁-C₂₀ alkyl, or —C₆-C₂₀ aryl;
R² is -L¹-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance, selected from hydrogen, —C₁-C₆ alkyl, and —C₁-C₆ heteroalkyl;
L¹ is, independently in each instance, a bond, C₁-C₃ alkylene, —(C═O)—C₂-C₄ alkylene, or —(C═O)(NR³)—C₁-C₃ alkylene;
an asterisk (*) denotes the point of attachment of the functional group to a carbon atom in the polymeric backbone;
wherein the polymer optionally comprises one or more other units; and
wherein the units may be ordered or randomly distributed.

Embodiment fifty-one: The polymer of embodiment 50, wherein R² is —C₁-C₂₀ alkyl or —C₆-C₂₀ aryl.

Embodiment fifty-two: A polymer comprising:
a polybutadiene backbone;
a unit comprising repeat units of a 1,2-alkene,
a unit comprising repeat units of a 1,4-alkene; and
a branched-substitution unit having a functional group of Formula (I) or a salt thereof:

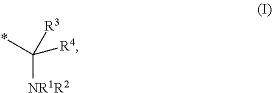

a linear-substitution unit having a functional group of Formula (I) or a salt thereof:
wherein
R¹ is hydrogen, —C₁-C₂₀ alkyl, or —C₆-C₂₀ aryl;
R² is -L¹-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
L¹ is, independently in each instance, a bond, C₁-C₃ alkylene, —(C═O)—C₂-C₄ alkylene, or —(C═O)(NR³)—C₁-C₃ alkylene;
an asterisk (*) denotes the point of attachment of the functional group to a carbon atom in the polymeric backbone;
wherein the polymer optionally comprises one or more other units; and
wherein the units may be ordered or randomly distributed.

Embodiment fifty-three: The polymer of embodiment 52, wherein R² is —C₁-C₂₀ alkyl or —C₆-C₂₀ aryl.

Embodiment fifty-four: The polymer of embodiment 52 having the following structure:

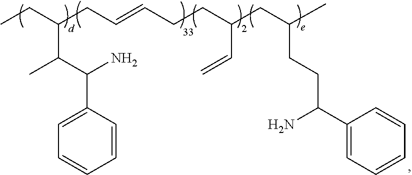

wherein the sum of subscript d and e is 9.

Embodiment fifty-five: A process for making a polymer comprising:
hydroaminoalkylating a polybutadiene polymer post-polymerization in the presence of at least 5 mol % of group 4 or 5 transition metal catalyst and a secondary amine to form a functionalized polymer, wherein the reaction temperature is 110° C.-165° C.,
producing the functionalized polymer comprising:
a polybutadiene backbone;
1,2-alkene units,
1,4-alkene units; and
a branched-substitution unit having a functional group of Formula (I) or a salt thereof:

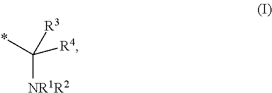

a linear-substitution unit having a functional group of Formula (I) or a salt thereof:
   wherein the molar ratio of the branched-substitution unit to the linear-substitution unit is 6:1 or greater;
R¹ is hydrogen, —C₁-C₂₀ alkyl, or —C₆-C₂₀ aryl;
R² is -L¹-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
L¹ is, independently in each instance, a bond, C₁-C₃ alkylene, —(C═O)—C₁-C₃ alkylene, or —(C═O)(NR³)—C₁-C₃ alkylene;
an asterisk (*) denotes the point of attachment of the functional group to a carbon atom in the polymeric backbone;
wherein the polymer optionally comprises one or more other units; and
wherein the units may be ordered or randomly distributed.

Embodiment fifty-six: The process of embodiment 55, wherein the catalyst is a Ta-based catalyst.

Embodiment fifty-seven: The process of embodiment 56, wherein R² is —C₁-C₂₀ alkyl or —C₆-C₂₀ aryl.

Embodiment fifty-eight: A process for making a polymer comprising:

functionalizing internal olefins of a polybutadiene polymer in the presence of at least 5 mol % of a group 4 or 5 transition metal catalyst and a secondary amine to form a functionalized polymer, wherein the reaction temperature is at least 140° C., wherein the functionalized polymer comprises:
a polybutadiene backbone;
1,2-alkene units,
1,4-alkene units; and
a 1,4-addition unit substituted with a functional group of Formula (I) or a salt thereof:

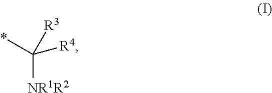

wherein
R¹ is hydrogen, —C₁-C₂₀ alkyl, or —C₆-C₂₀ aryl;
R² is -L-C₁-C₂₀ alkyl, -L¹-C₂-C₂₀ alkenyl, or -L-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —SCH₃, or a combination thereof;
R³ and R⁴ are, independently in each instance selected from hydrogen, —C₁-C₆ alkyl, and —C₁-C₆ heteroalkyl;
L¹ is, independently in each instance, a bond, C₁-C₃ alkylene, —(C═O)—C₁-C₃ alkylene, or —(C═O)(NR³)—C₁-C₃ alkylene;
an asterisk (*) denotes the point of attachment of the functional group to a carbon atom in the polymeric backbone;
wherein the polymer optionally comprises one or more other units; and
wherein the units may be ordered or randomly distributed.

Embodiment fifty-nine: The process of embodiment 58, wherein R² is —C₁-C₂₀ alkyl or —C₆-C₂₀ aryl.

Embodiment sixty: A process for making a polymer comprising:

hydroaminoalkylating a polybutadiene polymer in the presence of a Zr-based catalyst and a silyl-protected secondary amine to form a functionalized polymer, wherein the reaction temperature is at least 140° C., wherein the functionalized polymer comprises:
a polybutadiene backbone;
1,2-alkene units;
1,4-alkene units; and
a branched-substitution unit having a functional group of Formula (I) or a salt thereof:

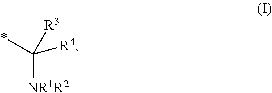

a linear-substitution unit having a functional group of Formula (I) or a salt thereof:
wherein
R¹ is hydrogen, —C₁-C₂₀ alkyl, or —C₆-C₂₀ aryl;
R² is -L¹-C₁-C₂₀ alkyl, -L¹-C₂-C₂₀ alkenyl, or -L¹-C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six groups selected from —F, —C₁, —I, —Br, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
L¹ is, independently in each instance, a bond, C₁-C₃ alkylene, —(C═O)—C₁-C₃ alkylene, or —(C═O)(NR³)—C₁-C₃ alkylene;
an asterisk (*) denotes the point of attachment of the functional group to a carbon atom in the polymeric backbone;
wherein the polymer optionally comprises other units; and
wherein the units may be ordered or randomly distributed.

Embodiment sixty-one: The process of embodiment 60, wherein the amine is N-benzyl silylamine.

Embodiment sixty-two: The process of embodiment 60, wherein R² is —C₁-C₂₀ alkyl or —C₆-C₂₀ aryl.

Embodiment sixty-three: A polymer made by the process of any one of embodiments 55-62.

Embodiment sixty-four: A polymer made by the process of any one of embodiments 55-62, wherein the process is solvent free.

Embodiment sixty-five: A process for hydrogenating the backbone of a polybutadiene polymer to prepare an aliphatic backbone polymer, comprising, reacting a polybutadiene polymer set forth herein under hydrogenation conditions, thereby preparing the aliphatic backbone polymer.

Embodiment sixty-six: The process of embodiment 65, wherein the hydrogenation conditions comprise using p-toluenesulfonyl hydrazide, tripropylamine, xylenes, or a combination thereof.

Embodiment sixty-seven: The process of any one of embodiments 65-66, wherein the hydrogenation conditions comprise a N₂ atmosphere.

Embodiment sixty-eight: The process of any one of embodiments 65-67, wherein the hydrogenation conditions comprise heating the polymer of any one of embodiments 1-21 or 27-28 under hydrogenation conditions to at least 100° C.

Embodiment sixty-nine: The process of any one of embodiments 65-32, wherein the hydrogenation conditions comprise heating the polymer of any one of embodiments 1-21 or 27-28 under hydrogenation conditions to 100° C. to 150° C.

Embodiment seventy: The process of any one of embodiments 65-69, wherein the hydrogenation conditions comprise heating the polymer of any one of embodiments 1-21 or 27-28 under hydrogenation conditions to 130° C.

Embodiment seventy-one: The process of any one of embodiments 65-70, wherein the hydrogenation conditions comprise heating the polymer of any one of embodiments 1-21 or 27-28 under hydrogenation conditions for twenty-four hours.

Embodiment seventy-two: The process of any one of embodiments 65-71, wherein the process further comprises reducing at least one, or both, R1 or R2 so that at least one, or both, R1 or R2 is H.

Embodiment seventy-three: The process of any one of embodiments 65-72, wherein the process further comprises reducing the polymer by reacting the polymer with ammonium cerium (II) nitrate.

Embodiment seventy-four: A polymer made by the process herein.

In some embodiments, including any of the foregoing, the hydrogenation process may be accomplished using a catalyst. For example, in some embodiments, including any of the foregoing, hydrogenation is accomplished using palladium on carbon catalysis. See one reaction scheme below:

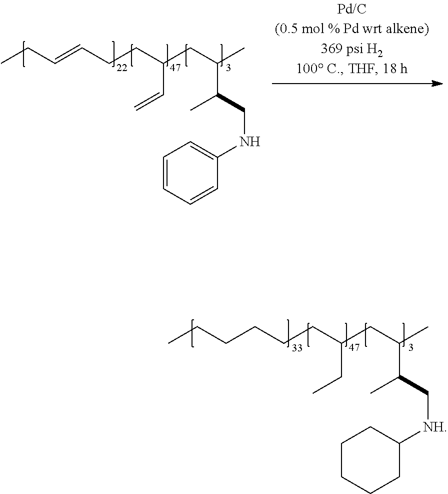

Other metal catalyzed hydrogenation processes are known and are herein incorporated by reference in their entirety for all purposes, such as, but not limited to, Martin P. McGrath, Erik D. Sall, and Samuel J. Tremont. Chemical Reviews 1995 95 (2), 381-398.

In some embodiments, including any of the foregoing, the hydrogenation process may be accomplished using electrochemical methods.

Embodiment seventy-five: A process for preparing an epoxide resin, comprising, reacting a polymer set forth herein with at least one epoxide monomer or precursor thereof, thereby preparing the epoxide resin.

Embodiment seventy-six: A process for preparing a mixture, comprising, providing a polymer set forth herein, and at least one epoxide monomer or precursor thereof, thereby preparing the mixture.

Embodiment seventy-seven: The process of any one of embodiments 75 or 76, wherein the epoxide monomer or precursor thereof has a structure selected from:

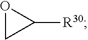

wherein R³⁰ is selected form hydrogen, C₁₋₆ alkyl,

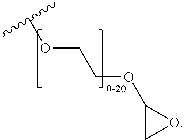

Embodiment sixty-eight: The process of any one of embodiments 75-77, wherein the epoxide monomer or precursor thereof has a structure selected from:

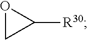

wherein R³⁰ is

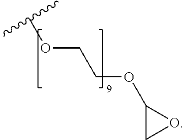

Embodiment sixty-nine: The process of any one of embodiments 75-78, wherein the epoxide monomer or precursor is poly(ethylene glycol) diglycidyl ether epoxide.

Embodiment eighty: The process of any one of embodiments 75-78, wherein the epoxide monomer or precursor is trimethylolpropane triglycidyl ether epoxide.

Embodiment eight-one: The process of any one of embodiments 75-78, wherein the one or more epoxide monomers or precursors thereof comprise epichlorohydrin or derivatives thereof.

Embodiment eighty-two: The process of any one of embodiments 75-78, wherein the one or more epoxide monomers or precursors thereof comprise bisphenol A, derivatives thereof, or combinations thereof. In some embodiments, including any of the foregoing, the epoxide monomer or precursor thereof is a bisphenol A diglycidyl ether resin, a butoxymethyl butyl glycidyl ether resin, a bisphenol A-epichlorohydrin resin, a bisphenol F resin, a polyepoxide resin, a bisphenol epoxy resin, a novolac resin, a polyester resin, an aldehyde resin, a phenolic resin, a terpolymer of phenol, a phenol-aldehyde resin, a phenolic formaldehyde resin, an urea-aldehyde resin, a furan resin, a furfuryl alcohol resin, a urethane resin, or a glycidyl ether resin.

Embodiment eighty-three: The process of any one of embodiments 75-78, wherein the one or more epoxide monomers or precursors have the following structure:

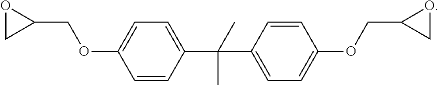 [SMILES: CC(C)(c1ccc(OCC2CO2)cc1)c1ccc(OCC2CO2)cc1]

Embodiment eighty-four: The process of any one of embodiments 75-78, wherein the one or more epoxide monomers or precursors have the following structure:

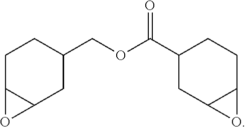 [SMILES: O=C(OCC1CCC2OC2C1)C1CCC2OC2C1]

Embodiment eighty-five: The process of any one of embodiments 75-78, wherein the one or more epoxide monomers or precursors has the following structure:

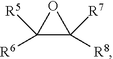

wherein R⁵, R⁶, R⁷, and R⁸, are each, independently in each instance selected from, or comprise, —C₁-C₂₀ alkyl, —C₁-C₂₀ alkoxy,−[PEG]₀₋₁₀,−[PEG]₀₋₁₀—(C₂H₄—O), C₁-C₁₀ heteroalkyl, C₆-C₂₀ aryl; C₃-C₂₀ heterocyclic ring having 0 to 2 additional heteroatoms selected from nitrogen and oxygen, wherein the heterocyclic ring may be a fused bicyclic ring, and wherein R⁵, R⁶, R⁷, and R⁸, are each, independently in each instance optionally substituted with one to six members selected from the group consisting of —F, —C₁, —I, —Br, —OH, —OCH₃, —OCF₃, —C₁-C₆ thioalkyl, and combinations thereof.

Embodiment eighty-six: The process of any one of embodiments 75-85, wherein the mixture further comprises a combination of epoxide monomers.

Embodiment eighty-seven: The process of any one of embodiments 75-86, wherein the mixture further comprises one or more additional hardeners.

Embodiment eighty-eight: The process of any one of embodiments 75-87, further comprising curing the mixture.

Embodiment eighty-nine: The process of any one of embodiments 75-88, further comprising crosslinking the polymer of any one of embodiments 1-21, 27-28, or 38-59.

Embodiment ninety: The process of any one of embodiments 75-89, further comprising hardening the mixture.

In some embodiments, including any of the foregoing, the process includes the following reaction:

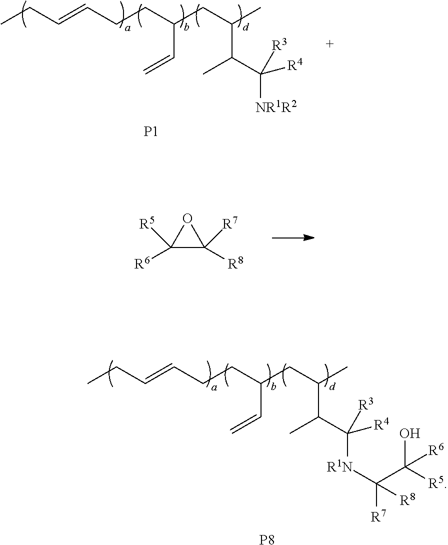

In the above reaction, in some preferred embodiments, R¹ is H.

In the above reaction, in some preferred embodiments, R¹ is H and R² is an alkyl group, e.g., C₁-20 alkyl or C₁₋₂₀ cycloalkyl. In some embodiments, R² is methyl. In some embodiments, R² is ethyl. In some embodiments, R² is propyl. In some embodiments, R² is butyl. In some embodiments, R² is pentyl. In some embodiments, R² is hexyl. In some embodiments, R² is cyclohexyl.

In the above reaction, in some preferred embodiments, R¹ and R² are both H.

In some embodiments, including any of the foregoing, the mixture becomes cured or hardened by the amine functionalized polybutadiene. In this regard, curing agents are herein used interchangeably with hardeners unless stated otherwise.

In some embodiments, including any of the foregoing, the final cured mixture has improved properties, such as mechanical, adhesive, and improved processing.

In some embodiments, including any of the foregoing, the product of the aforementioned epoxide ring opening reactions is characterized by a distinctive infrared (IR) mode at 1090 cm⁻¹ to 1115 cm⁻¹.

In some embodiments, including any of the foregoing, the product of the aforementioned epoxide ring opening reactions is characterized by a distinctive infrared (IR) mode at 1110 cm⁻¹ assigned to C—O stretch from reaction product.

In some embodiments, including any of the foregoing, the product of the aforementioned epoxide ring opening reactions is characterized by a distinctive IR mode at 1095 cm⁻¹ assigned to C—O stretch from reaction product.

In some embodiments, including any of the foregoing, the polybutadiene starting material (i.e., reagent) is a liquid with a molecular weight that is on average 2,500 to 4,500 g/mol.

In some other embodiments, including any of the foregoing, the polybutadiene starting material (i.e., reagent) is a solid with a molecular weight that is on average 70,000 to 80,000 g/mol.

In some other embodiments, including any of the foregoing, the polybutadiene starting material (i.e., reagent) is a solid with a molecular weight that is on average 72,000 g/mol.

In some other embodiments, including any of the foregoing, the polybutadiene starting material (i.e., reagent) is a solid with a molecular weight that is on average 65,000 g/mol.

### Examples

Additional embodiments are disclosed in further detail in the following examples, which are not in any way intended to limit the scope of the claims.

### Analytical Methods and Instrumentation

Proton nuclear magnetic resonance (NMR) spectra were obtained on Bruker Avance™ 300 or 400 MHz spectrometer. NMR spectra are reported as follows: chemical shift δ (ppm), multiplicity, coupling constant J (Hz), and integration. The abbreviations s=singlet, d=doublet, t=triplet, q=quartet, m=multiplet and br=broad are used throughout. ¹H and ¹³C NMR resonances were rigorously assigned using COSY, HSQC, and HMBC 2D NMR spectroscopy experiments.

Mass spectral data were measured using a Jeol AccuTOF-GCv 4G spectrometer equipped with a Field Desorption/Ionization (FD/FI) ion source. The samples were dissolved in DCM and were loaded to a FD probe then introduced into the ion source of GC-TOF MS. Mass spectra were acquired in positive mode and fragments are given in mass per charge number (m/z). FT-IR data were were recorded at room temperature on a Perkin Elmer FT-IR equipped with an ATR accessory for direct measurement on oils and polymeric materials.

### Experimental Conditions

Air and moisture sensitive reactions were prepared in a MBraun LABmaster glovebox filled with N₂ atmosphere. All glassware was dried overnight in an oven at 160° C. prior to transferring to the glovebox or usage on the Schlenk manifold. Toluene was passed through an activated alumina column under N₂ gas, collected in a Teflon sealed Straus flask and sparged with N₂ for 30 minutes prior to use. Toluene-d₈ was dried over sodium metal, distilled under N₂ atmosphere, and collected in a Teflon sealed Straus flask and degassed prior to use. Screening hydroaminoalkylation reactions were performed in a J-Young tube (8″×5 mm) sealed with a Teflon screw cap.

### Materials

Liquid polybutadiene materials, Ricon® 100 (PBD-co-PS4.5-54) R¹, Ricon® 130 (PBD2.5-28) R², and Ricon® 150 (PBD3.9-70) R³ (as shown in Scheme 2). Number of repeat units were calculated based on the reported molecular weight and mass percent (wt %) content reports by Cray Valley (see example calculation in equations section). Reported repeat unit values are rounded to the nearest whole number. These materials were dissolved in hexanes, dried with CaH₂, filtered, degassed with three freeze-pump-thaw cycles, and solvents were removed in vacuo. The materials were stored under inert N₂ atmosphere prior to use. The tantalum precatalyst was synthesized as described in previous literature and generated in situ prior to use. Daneshmand et al., J Am. Chem. Soc. 2020, 142 (37): 15740-15750. N-methylaniline was purchased from MillaporeSigma, N-methylcyclohexylamine and N-methylbutylamine were purchased from Oakwood Chemical, all amine reagents were dried over CaH₂ and distilled prior to being stored in an inert N₂ glovebox atmosphere. 1,3,5-trimethoxybenzene was commercially available from Oakwood Chemical and sublimed prior to storage in the glovebox.

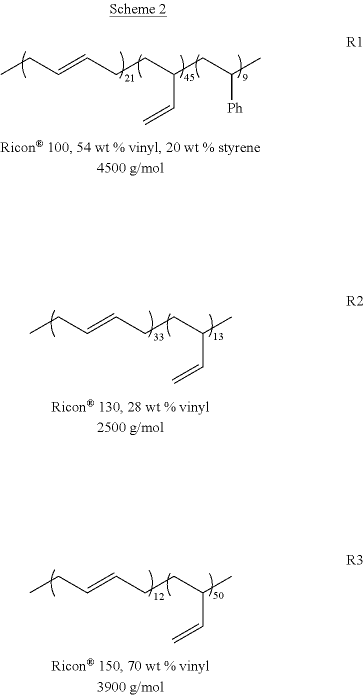

Ricon® materials were used herein unless stated otherwise.

Abbreviations used in the examples include:

| Abbreviation | Name |
|---|---|
| CaH₂ | Calcium hydride |
| DCM | Dichloromethane |
| HAA | Hydroaminoalkylation |
| MW | Molecular weight |
| MeOH | Methanol |
| N₂ | Nitrogen gas |
| % | Percentage |
| TON | Turn over number |
| TaCl₂(CH₂SiMe₃) | ((trimethylsilyl)methyl)tantalum(III) chloride |
| Ta | Tantalum |
| Zr(NMe₂)₄ | Tetrakis(dimethylamino)zirconium |

### General Scheme for Preparing Branched HAA Product

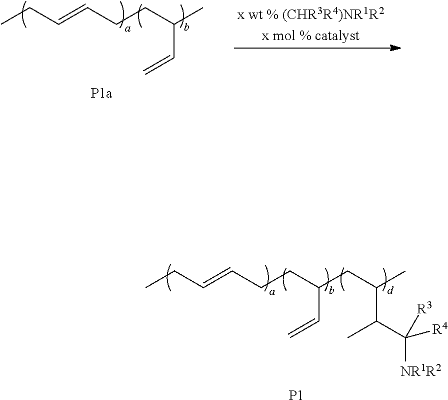

Scheme A1. In certain embodiments, hydroaminoalkylation comprises alkylation of polymer Pla with amine with the appropriate catalyst to give alkylated product P1 as shown in Scheme A1. In certain embodiments, variable degrees of functionalization (b:d ratio in the product) can be achieved by tuning reaction conditions. In certain embodiments, the ratio of a:b (blocks derived from 1,4 and 1,2 addition of butadiene in the polymer respectively) in the starting polymer reactant can also vary. In certain embodiments, alkylated products can contain >90% branched HAA product. In certain embodiments, the % vinyl consumed (defined by ¹H NMR spectroscopy) is up to 100%.

### General Scheme for Preparing Polymer with an Additional Block (“e” Block)

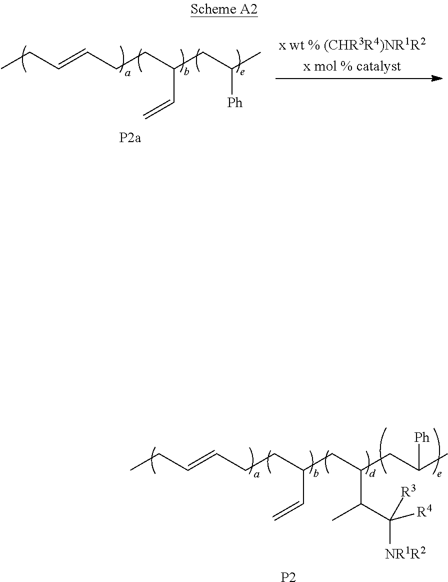

Scheme A2. In certain embodiments, the functionalized polymer can contain an optional additional block, such as of polystyrene (“e” unit). In certain embodiments, hydroaminoalkylation comprises alkylation of polymer precursor P2a with amine with the appropriate catalyst to give alkylated product P2.

### General Scheme for preparing primary amine product

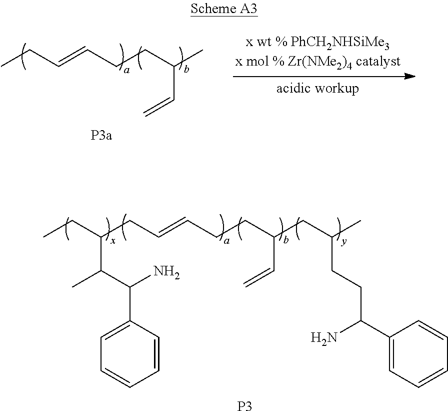

Scheme A3. In certain embodiments, the functionalized polymer can contain a primary amine product. In certain embodiments, subjecting polymer precursor P3a under hydroaminoalkylation reaction conditions using a Zr-based catalyst and benzylamine can give primary amine product P3.

### General Scheme for preparing 1,4-addition products

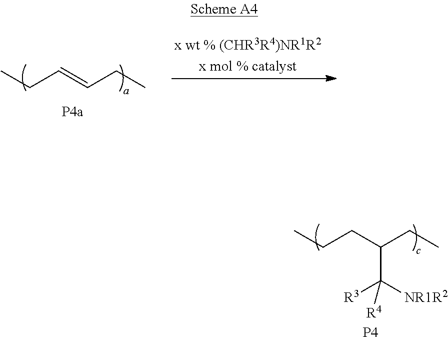

Scheme A4. In certain embodiments, 1,4 addition products such as P4 can be prepared from functionalization of internal olefins such as P4a.

### Catalyst: Hydroaminoalkylation

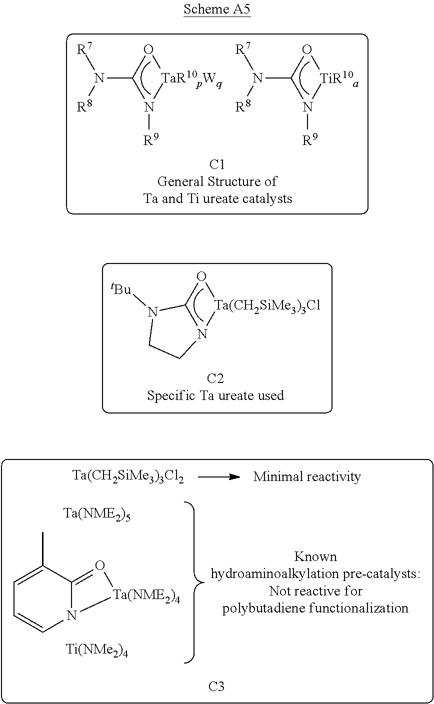

Scheme A5. In Scheme A5, p is an integer from 0 to 4 and q is an integer from 0 to 4, or the sum of p and q is 3 or 4; each W is a halogen substituent; R⁷ and R⁸ are each independently hydrogen, substituted or unsubstituted —C₁-C₄₀ linear alkyl, substituted or unsubstituted —C₁-C₄₀ branched alkyl, substituted or unsubstituted —C₁-C₄₀ cyclic alkyl, substituted or unsubstituted —C₁-C₄₀ alkenyl, substituted or unsubstituted —C₁-C₄₀ alkynyl, substituted or unsubstituted aryl, or substituted or unsubstituted heterocyclic, or R⁷ and R⁸ together with the nitrogen to which they are both attached form a heterocycle; R⁹ is hydrogen, a substituted or unsubstituted —C₁-C₄₀ linear alkyl, substituted or unsubstituted —C₁-C₄₀ branched alkyl, substituted or unsubstituted —C₁-C₄₀ cyclic alkyl, substituted or unsubstituted —C₁-C₄₀ alkenyl, substituted or unsubstituted —C₁-C₄₀ alkynyl, substituted or unsubstituted aryl, substituted or unsubstituted heterocyclic, or R⁹ together with R⁷ and/or R⁸ to form a heterocycle.

In some embodiments, including any of the foregoing, R⁷ and R⁸ may have the definitions of either or both of R¹ or R² in embodiments above. For example, in some embodiments, either R⁷ or R⁸, or both, are hydrogen. In certain embodiments, either R⁷ or R⁸, or both, are —C₁-C₂₀ alkyl. In certain embodiments, either R⁷ or R⁸, or both, are —C₆-C₂₀ aryl.

In certain embodiments, R⁷ is —C₁-C₂₀ alkyl. In certain embodiments, R⁷ is —C₆-C₂₀ aryl. In certain embodiments, R⁸ is —C₁-C₂₀ alkyl. In certain embodiments, R⁸ is —C₆-C₂₀ aryl. In certain embodiments, R⁷ and R⁸ together with the nitrogen to which they are both attached form a —C₃-C₂₀ heterocyclic ring having 0 to 2 additional heteroatoms selected from nitrogen and oxygen In certain embodiments, R⁷ and R⁸ are each independently optionally substituted with one to six groups selected from —F, —C₁, —I, —Br, —OCH₃, —OCF₃, and —C₁-C₆ thioalkyl, or a combination thereof. In certain embodiments, the aryl group in R⁷ is optionally para-substituted. In certain embodiments, the aryl group in R⁸ is optionally para-substituted.

In certain embodiments, p is an integer from 0 to 4 and q is an integer from 0 to 4. In certain embodiments, p is an integer from 0 to 4. In certain embodiments, q is an integer from 0 to 4. In certain embodiments, the sum of p and q is 3 or 4. In certain embodiments, the sum of p and q is 3. In certain embodiments, the sum of p and q is 4.

In certain embodiments, each W is a halogen substituent.

In certain embodiments, R⁷ and R⁸ are each independently hydrogen, substituted or unsubstituted —C₁-C₄₀ linear alkyl, substituted or unsubstituted —C₁-C₄₀ branched alkyl, substituted or unsubstituted —C₁-C₄₀ cyclic alkyl, substituted or unsubstituted —C₁-C₄₀ alkenyl, substituted or unsubstituted —C₁-C₄₀ alkynyl, substituted or unsubstituted aryl, or substituted or unsubstituted heterocyclic. In certain embodiments, R⁷ and R⁸ together with the nitrogen to which they are both attached form a heterocycle.

In certain embodiments, R⁷ is hydrogen. In certain embodiments, R⁷ is substituted or unsubstituted —C₁-C₄₀ linear alkyl. In certain embodiments, R⁷ is substituted or unsubstituted —C₁-C₄₀ branched alkyl. In certain embodiments, R⁷ is substituted or unsubstituted —C₁-C₄₀ cyclic alkyl. In certain embodiments, R⁷ is substituted or unsubstituted —C₁-C₄₀ alkenyl. In certain embodiments, R⁷ is substituted or unsubstituted —C₁-C₄₀ alkynyl. In certain embodiments, R⁷ is substituted or unsubstituted aryl. In certain embodiments, R⁷ is substituted or unsubstituted heterocyclic.

In certain embodiments, R⁸ is hydrogen. In certain embodiments, R⁸ is substituted or unsubstituted —C₁-C₄₀ linear alkyl. In certain embodiments, R⁸ is substituted or unsubstituted —C₁-C₄₀ branched alkyl. In certain embodiments, R⁸ is substituted or unsubstituted —C₁-C₄₀ cyclic alkyl. In certain embodiments, R⁸ is substituted or unsubstituted —C₁-C₄₀ alkenyl. In certain embodiments, R⁸ is substituted or unsubstituted —C₁-C₄₀ alkynyl. In certain embodiments, R⁸ is substituted or unsubstituted aryl. In certain embodiments, R⁸ is substituted or unsubstituted heterocyclic.

In certain embodiments, R⁹ is hydrogen. In certain embodiments, R⁹ is substituted or unsubstituted —C₁-C₄₀ linear alkyl. In certain embodiments, R⁹ is substituted or unsubstituted —C₁-C₄₀ branched alkyl. In certain embodiments, R⁹ is substituted or unsubstituted —C₁-C₄₀ cyclic alkyl. In certain embodiments, R⁹ is substituted or unsubstituted —C₁-C₄₀ alkenyl. In certain embodiments, R⁹ is substituted or unsubstituted —C₁-C₄₀ alkynyl. In certain embodiments, R⁹ is substituted or unsubstituted aryl. In certain embodiments, R⁹ is substituted or unsubstituted heterocyclic.

In Scheme A5, Ta-based catalyst to perform hydroaminoalkylation reaction are selected from Catalyst C₁, C₂ and C₃. In certain embodiments, polymer functionalization is afforded through the use of catalyst a reactive group 4 or 5 hydroaminoalkylation catalyst. In certain embodiments, for obtaining reactivity, the formation of highly reactive electrophilic catalysts using N,O-chelated ligands is required, for example a cyclic ureate C₁ or C₂. In certain embodiments, the N,O-chelating catalysts can be isolated or generated in situ by providing Ta(CH₂SiMe₃)₃Cl₂ with one equivalent of the alkali salt of the N,O-chelate (for example sodium ureate). In certain embodiments, the catalyst is C₂.

### General Scheme: Hydroaminoalkylation

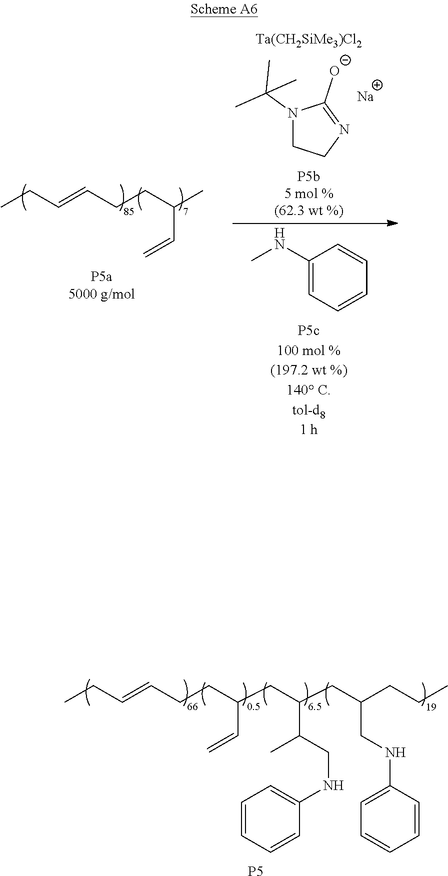

Scheme A6. In certain embodiments, Scheme A5 showed reaction conditions to perform hydroaminoalkylation on 5000 g/mol liquid polybutadiene with 92% 1,4-repeat units and 8% 1,2-repeat units. In certain embodiments, treatment of polymer P5a with N-methyl aniline (P5c) in the presence of Ta-based catalyst and ligand P5b gave alkylated product P5. Described below are detail reaction procedures and additional examples of polymers that may be prepared according to Scheme A6.

### General Procedure 1: For In Situ Catalyst Generation

Tantalum precursor (TaCl₂(CH₂SiMe₃)) was added to a vial containing ligand and toluene-d8 (0.10 mL). The mixture was stirred to generate the green precatalyst. The liquid polybutadiene (Ricon® 100, Ricon® 130, Ricon® 150) (0.10 g), amine (varying amounts), and 1,3,5-trimethoxybenzene (0.016 mg) were weighed out separately. See Scheme 2 above for the chemical structure of these polybutadiene polymers. The amine was transferred to the precatalyst mixture, which were then quantitatively transferred into the J-Young NMR spectroscopy tube with toluene-d₈ along with the liquid polybutadiene and the 1,3,5-trimethoxybenzene internal standard. The total mass of each reaction solution was 0.60 mg. ¹H NMR spectrum was recorded for the t=0 h time point prior to heating. The reaction was heated to 140° C. (unless otherwise stated) with a silicon oil bath where the solvent line was aligned with the oil bath level. After 1 h of heating. ¹H NMR spectrum was recorded for the t=1 h time point. For select reactions the reaction vessels were heated for an additional 2 h, 4 h, and 23 h to obtain a t=3 h, t=5 h, t=24 h ¹H NMR spectra, respectively. Reactions were stopped by removal from the heating source and exposing the reaction to air to oxidize the catalyst. Materials were isolated by filtering through a 1-inch Celite® pad and precipitating three times from a concentrated DCM solution into either cold MeOH or acetone. The final product was collected and dried in vacuo overnight prior to characterization. In certain embodiments, the molar ratio of tantalum precursor to ligand is 1:1.

### Example 1: Synthesis of Compound 1

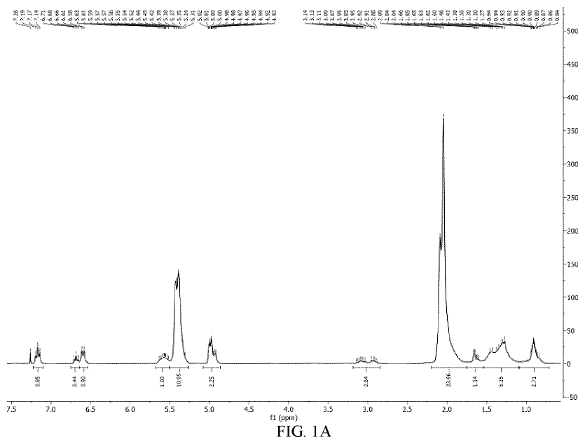

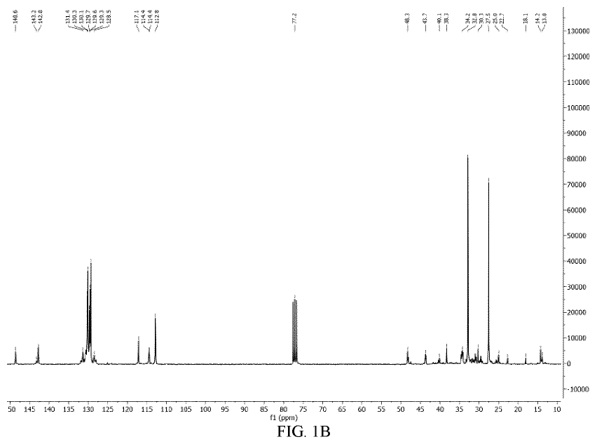

Compound 1 was synthesized by using the same procedure as general procedure 1 with Ricon® 130 R2 and N-methyl aniline (50 mg) using the generation of catalyst C2 in-situ (12 mg of Ta(CH₂SiMe₃)₃Cl₂ and 3.8 mg of ureate ligand salt). See Scheme 2 above for the chemical structure of these polybutadiene polymers. Obtained Compound 1 (91 mg, 81%). ¹H NMR (300 MHz, CDCl₃, 298 K) δ=7.16 (t, br, H1); 6.67-6.61 (overlapping t and d, br, 2H); 5.56 (m, br, 1H); 5.38 (m, br, 2H); 4.96 (m, br, 1H); 3.08-2.94 (d, m, br, 1H); 2.03 (m, br, 2H); 1.63-0.85 (m, br, 7); 0.88 (overlapping s, 3H); ¹³C{¹H} NMR (300 MHz, CDCl₃, 298 K) δ=148.6, 142.8, 131.4, 128.5, 117.1, 114.4, 112.8, 48.3, 38.3, 34.2, 32.9, 32.8, 30.3, 27.5, 25.0, 22.7 and 14.3; LCMS: C₁₇H₂₅N₃O₄ requires: 335, found: m/z=336 [M+H]⁺. In certain embodiments, some of the ¹³C{¹H} NMR chemical shifts are hard to see so the values were determined in conjunction with the spectrum of FIG. 1A. FIG. 1B shows ¹³C{¹H}NMR spectrum of Compound 1.

### Example 2: Synthesis of Compound 2

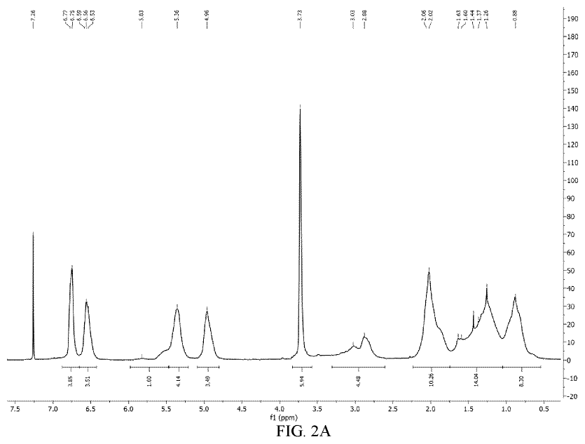

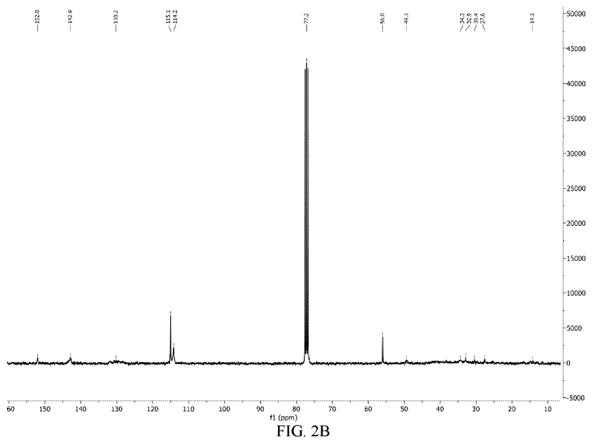

Compound 2 was synthesized using the same general procedure 1 with Ricon® 130 R2. ¹H NMR (300 MHz, CDCl₃, 298 K) δ=6.77, 6.75 (H3); 6.59, 6.56, 6.53 (H4); 5.83 (H14); 5.36 (H17 & H18); 4.96 (H15); 3.73 (H1); 3.03, 2.88 (H7); 2.06, 2.02 (H16 & H19); 1.63, 1.60, 1.44, 1.37, 1.26, 0.88 (H8-H13 overlapping) ppm; ¹³C{¹H} NMR (75 MHz, CDCl₃, 298 K) δ=152.0, 142.9, 130.2, 115.1, 114.2, 56.0, 49.3, 34.3, 32.9, 30.4, 27.6, 14.3 ppm. FIG. 2A shows ¹H NMR spectrum of Compound 2. FIG. 2B shows ¹³C{¹H}NMR spectrum of Compound 2.

### Example 3: Synthesis of Compound 3

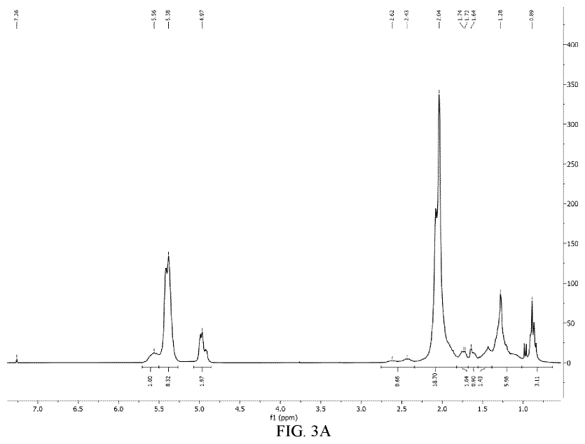

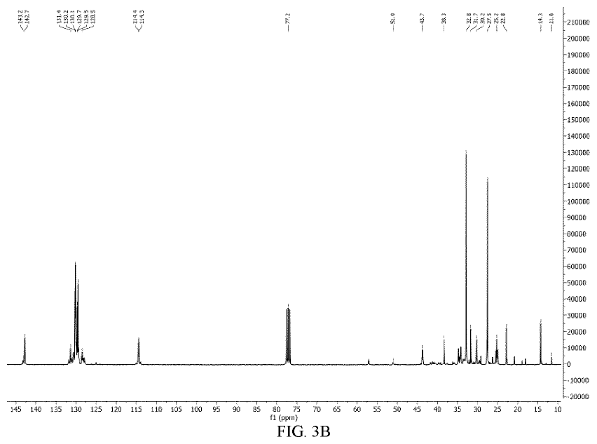

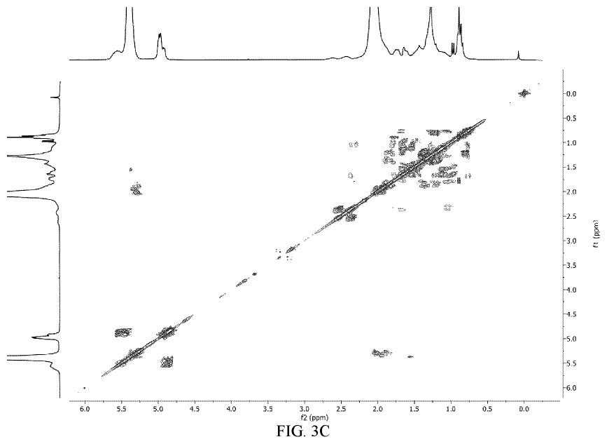

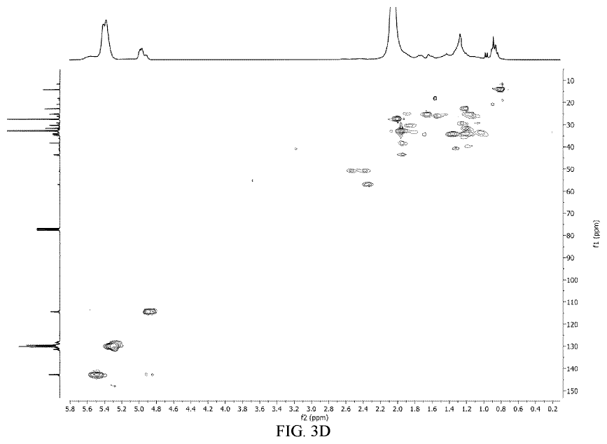

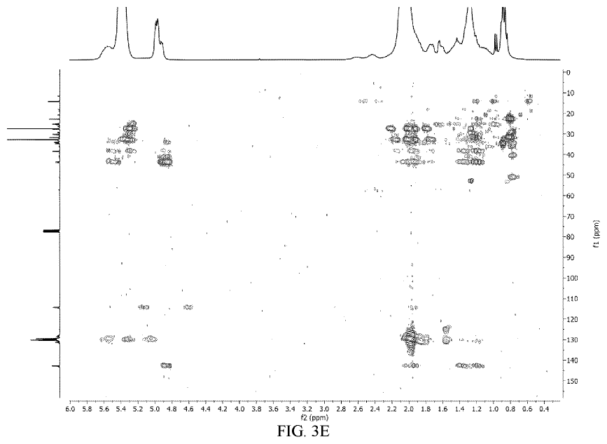

Compound 3 was synthesized by using the same procedure as general procedure 1 with Ricon® 130 R² and 150 wt % N-methylcyclohexylamine (150 mg) in the presence of tantalum catalyst (34 mg of Ta(CH₂SiMe₃)₃Cl₂ and 10.9 mg of ureate ligand salt) and heating to reaction mixture at 140° C. for 1 hour. Obtained Compound 3 (82 g, 65%). ¹H NMR (300 MHz, CDCl₃, 298 K) δ=5.64, 5.62, 5.61, 5.58, 5.56, 5.54, 5.54, 5.50, (m, br, H13); 5.42, 5.41, 5.39, 5.37 (m, br, H16 & H17); 5.01, 5.00, 4.99, 4.97, 4.96, 4.95, 4.94, 4.93, 4.91 (m, br, H14); 2.62, 2.61, 2.59, 2.57, 2.47, 2.44, 2.41 (d, m, br, H6 overlapping with H4); 2.12, 2.08, 2.04 (m, br, H15 & H18 overlapping with H3); 1.78, 1.76, 1.75, 1.74, 1.72, 1.70 (H2); 1.65, 1.64, 1.62, 1.61, 1.60, 1.59 (H1); 1.57 (H7); 1.54, 1.52, 1.51, 1.50, 1.49, 1.47, 1.45, 1.43, 1.42, 1.39, 1.37, 1.36, 1.34, 1.33, 1.31, 1.30, 1.28, 1.27, 1.25, 1.23 (H9-H12); 0.98, 0.96 (d, H8); 0.91, 0.89, 0.86, 0.84 (m, br, end groups) ppm. ¹³C{¹H} NMR (75 MHz, CDCl₃, 298 K) δ=143.2, 142.8, 142.7 (C13); 131.4, 131.1, 130.7, 130.6, 130.5, 130.2, 120.1, 129.9, 129.7, 129.5, 129.4, 128.6, 128.5, 128.3, 128.2, 128.0 (C16, C17 overlapping); 115.0, 114.4, 114.3, 114.0 (C14); 57.1 (C4); 51.0 (C6); 43.9, 43.7, 43.6 (C11); 41.7, 41.2, 40.9 (C9); 34.8, 34.2, 34.1 (C7, Cl₂ overlapping); 32.8 (C15 & C18-trans); 31.7 (C10); 30.3, 30.2 (C3); 27.5 (C15 & C18-cis); 26.3 (C1); 25.4, 25.2, 25.1, 25.0 (C2) ppm. C8 undetermined. FIG. 3A shows ¹H NMR spectrum of Compound 3. FIG. 3B shows ¹³C{¹H} NMR spectrum of Compound 3. FIG. 3C shows ¹H-¹H COSY NMR spectrum of Compound 3. FIG. 3D shows H-¹³C{¹H} HSQC NMR spectrum of Compound 3. FIG. 3E shows ¹H-¹³C{¹H} HMBC NMR spectrum of Compound 3.

### Example 4: Synthesis of Compound 4

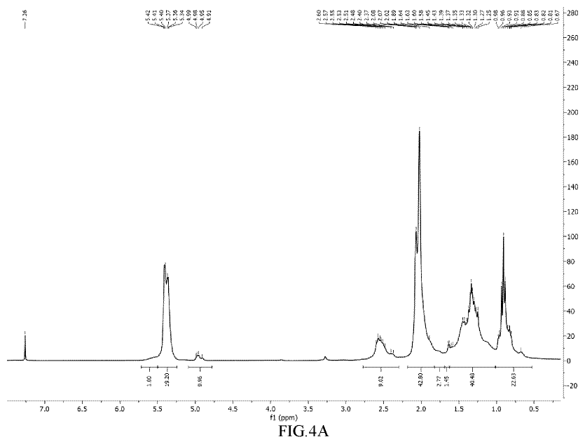

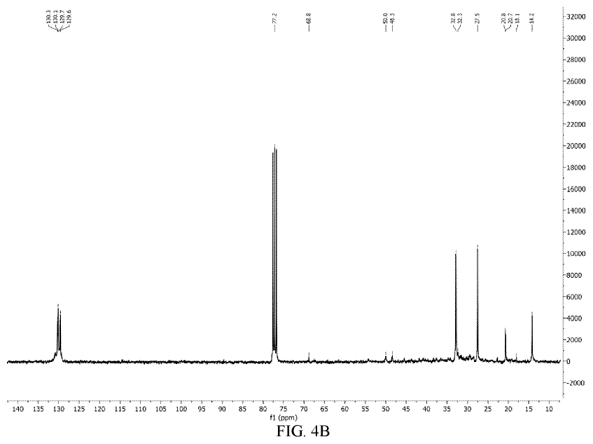

Compound 4 was synthesized by using the same procedure as general procedure 1 with Ricon® 130 R² and N-methyl butylamine using the generation of catalyst C2 in-situ. ¹H NMR (300 MHz, CDCl₃, 298 K) δ=5.42, 5.41, 5.40, 5.37, 5.36, 5.34 (H16 & H17 overlapping); 4.99, 4.98, 4.95, 4.91 (H14); 2.60, 2.57, 2.55, 2.53, 2.51, 2.48, 2.40, 2.37 (H4 &H6 overlapping); 2.08, 2.07, 2.02, 1.89 (H15 & H18 shoulder overlapping with H9 & H11); 1.64, 1.63, 1.60, 1.58; 1.45, 1.43 (H3); 1.39, 1.37, 1.35, 1.33, 1.32, 1.30, 1.27, 1.25 (H2, H10, H12 overlapping); 0.98, 0.96, 0.93, 0.91, 0.88, 0.85, 0.83, 0.82, 0.81, 0.67 (H1, H8 & end groups overlapping) ppm. ¹³C{¹H} NMR (75 MHz, CDCl₃, 298 K) δ=130.3, 129.7, 129.6 (C14); 114.4 (C13 observed through HSQC); 68.8 (C4 when activated in HAA to form methine); 50.0 (C4); 48.4 (C6); 32.9 (C15 & C18-trans); 32.4 (C3); 27.5 (C15 & C18-cis); 20.8, 20.7 (C2); 18.1; 14.2 (C1) ppm. Unobserved: C9-Cl₂. FIG. 4A shows ¹H NMR spectrum of Compound 4. FIG. 4B shows ¹³C{¹H} NMR spectrum of Compound 4.

### Example 5: Synthesis of Compound 5

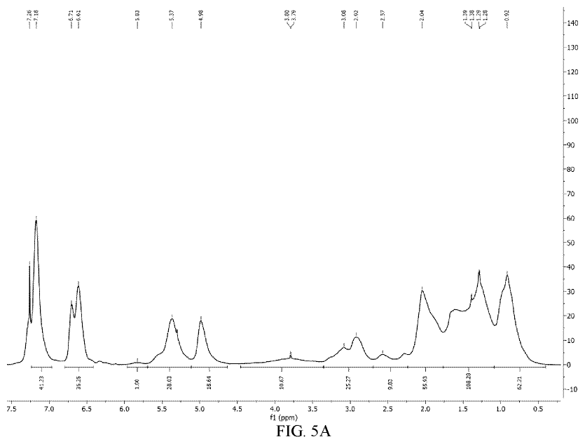

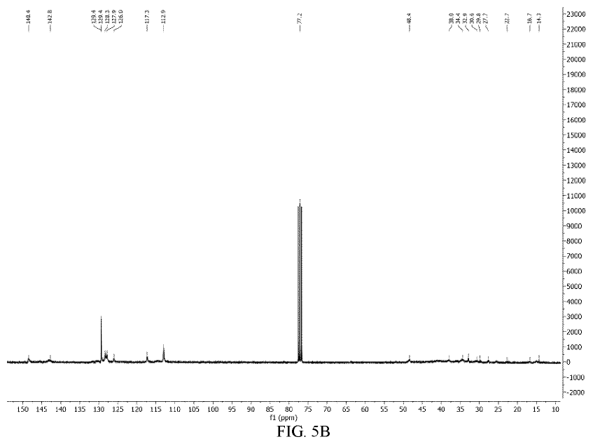

Compound 5 was synthesized by using the same procedure as general procedure 1 with Ricon® 100 R1 and N-methyl aniline using the generation of catalyst C2 in-situ. ¹H NMR (300 MHz, CDCl₃, 298 K) δ=7.18 (H2 & H13 overlapping); 6.71 (H1); 6.61 (H3); 5.83 (H16); 5.37 (H19 & H20); 4.98 (H17); 3.80, 3.79; 3.08, 2.92, 2.57(H6); 2.04 (H18 & H121); 1.39, 1.38, 1.29, 1.28, (H7, H9-H12, overlapping); 0.92 (H8, end groups overlapping) ppm. ¹³C{¹H} NMR (75 MHz, CDCl₃, 298 K) δ=148.4 (C4); 142.8 (C16); 129.4, 129.4, 128.3, 127.9, 126.0 (C2, C16, C17 overlapping); 117.3 (C1); 112.9 (C3); 48.4 (C6); 38.0 (C7); 32.9 (C18 & C21-trans); 34.4, 30.6, 29.8, 22.7, (C9-Cl₂ overlapping); 27.7 (C18 & C21-trans); 16.7, 14.3 (C8) ppm. Unobserved: C17. FIG. 5A shows ¹H NMR spectrum of Compound 5. FIG. 5B shows ¹³C{¹H} NMR spectrum of Compound 5.

### Example 4: Synthesis of Compound 6

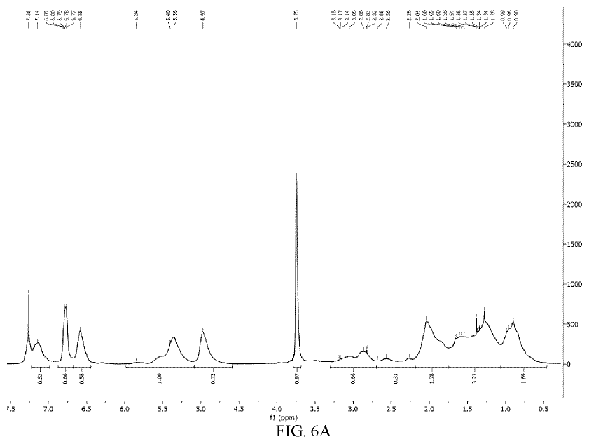

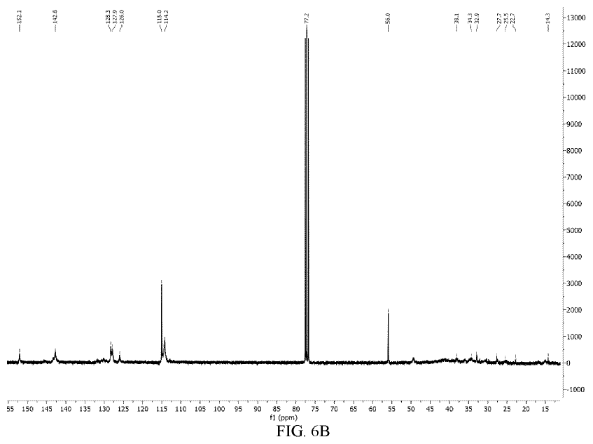

Compound 6 was synthesized by using the same procedure as general procedure 1 with Ricon® 100 R1 and N-methyl aniline (101 mg) using the generation of catalyst C2 in-situ (24.2 mg of Ta(CH₂SiMe₃)₃Cl₂ and 7.7 mg of ureate ligand salt). Obtained Compound 6 (124 mg, 71%). ¹H NMR (300 MHz, CDCl₃, 298 K) δ=7.18 (H2 & H13 overlapping); 6.71 (H1); 6.61 (H3); 5.83 (H16); 5.37 (H19 & H20); 4.98 (H17); 3.80, 3.79; 3.08, 2.92, 2.57(H6); 2.04 (H18 & H121); 1.39, 1.38, 1.29, 1.28, (H7, H9-H12, overlapping); 0.92 (H8, end groups overlapping) ppm. ¹³C{¹H} NMR (75 MHz, CDCl₃, 298 K) δ=148.4 (C4); 142.8 (C16); 129.4, 129.4, 128.3, 127.9, 126.0 (C2, C16, C17 overlapping); 117.3 (C1); 112.9 (C3); 48.4 (C6); 38.0 (C7); 32.9 (C18 & C21-trans); 34.4, 30.6, 29.8, 22.7, (C9-Cl₂ overlapping); 27.7 (C18 & C21-trans); 16.7, 14.3 (C8) ppm. Unobserved: C17. FIG. 6A shows ¹H NMR spectrum of Compound 6. FIG. 6B shows ¹³C{¹H} NMR spectrum of Compound 6.

### Example 7: Synthesis of Compound 7

Compound 7 was synthesized by using the same procedure as general procedure 1 with Ricon® 100 R1 and N-methyl cyclohexylamine using the generation of catalyst C2 in-situ. ¹H NMR (300 MHz, CDCl₃, 298 K) δ=7.13 (H13), 5.79, 5.52 (H16); 5.34 (H19 & H20); 4.95 (H17); 2.56, 2.36, 2.26 (H4 & H6 overlapping); 2.02 (H18 & H21); 1.70, 1.63, 1.59, 1.35, 1.28, 1.26, 1.23, 1.20, 0.88, 0.85, 0.83 (H1-H3, H9-H15 overlapping) ppm. FIG. 7 shows ¹H NMR spectrum of Compound 7.

### Example 8: Synthesis of Compound 8

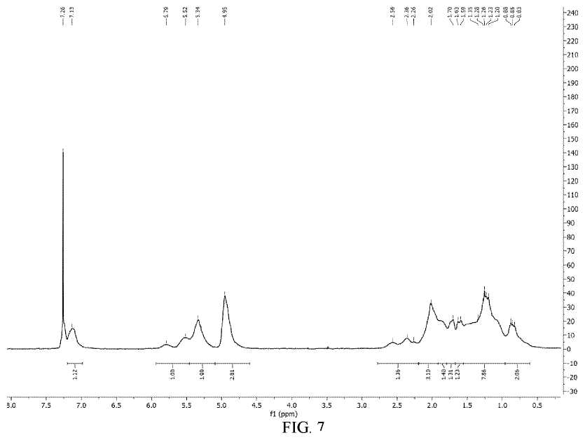

Compound 8 was synthesized using 9.4 wt % Zr(NMe₂)₄, 42 wt % N-benzyltrimethylsilylamine, and 0.1 g of Ricon 130 R¹. The reaction was heated at 145° C. for up to 400 hours for maximum reaction of the vinyl groups. A mixture of branched and linear products is obtained. ¹H NMR (300 MHz, C₆D₆, 298 K) δ 7.08, δ 5.45, δ 4.99, δ 3.99, δ 3.75, δ 2.37, δ 2.09-1.00. FIG. 8 shows stacked ¹H NMR spectra prior and post-heating of the reaction of Compound 8.

### Example 5: Synthesis of Compound 9

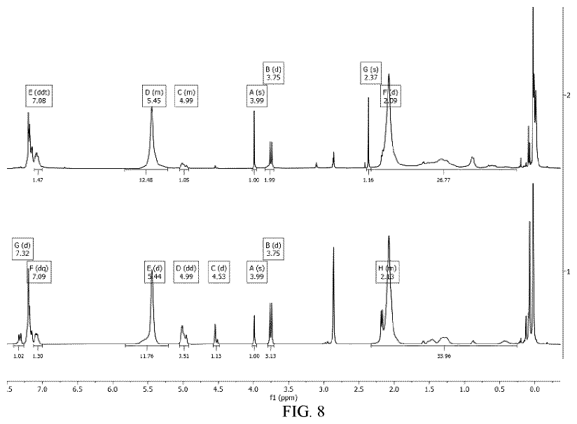

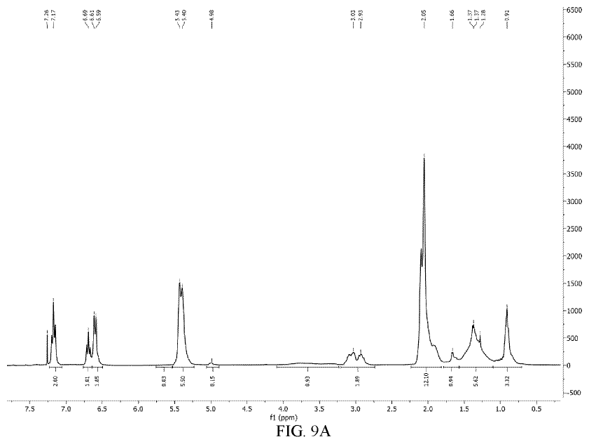

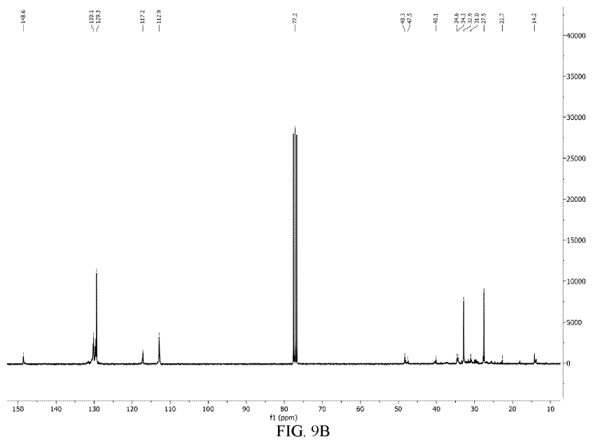

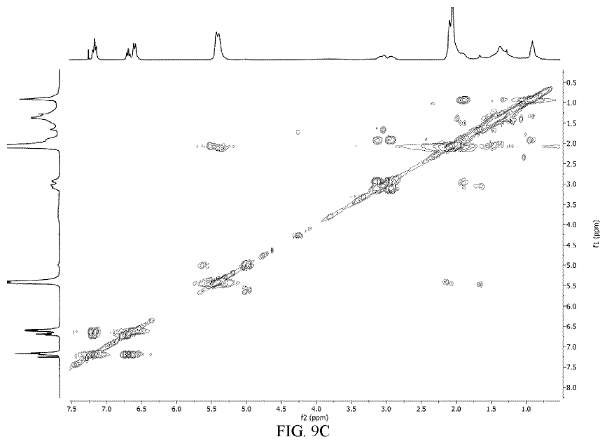

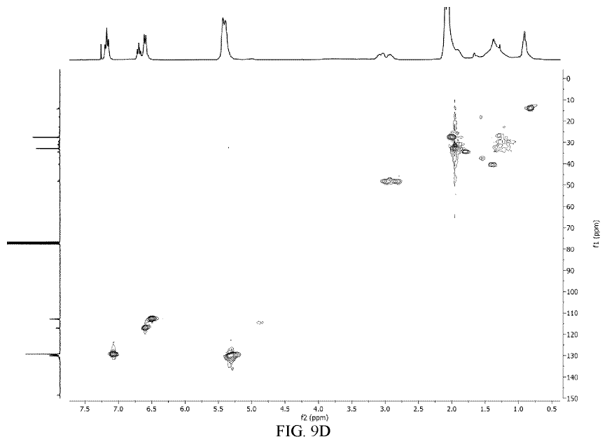

Compound 9 was synthesized by using the same procedure as general procedure 1 with Ricon® 130 R1 and 200 wt % N-methylaniline (200 mg) in the presence of 5 mol % tantalum catalyst (47.9 mg of Ta(CH₂SiMe₃)₃Cl₂ and 15.3 mg of ureate ligand salt) and heating to reaction mixture at 140° C. for 1 hour. Obtained Compound 9 (42.3 mg, 23%). ¹H NMR (300 MHz, CDCl₃, 298 K) δ=7.18 (H2 & H13 overlapping); 6.71 (H1); 6.61 (H3); 5.83 (H16); 5.37 (H19 & H20); 4.98 (H17); 3.80, 3.79; 3.08, 2.92, 2.57(H6); 2.04 (H18 & H121); 1.39, 1.38, 1.29, 1.28, (H7, H9-H12, overlapping); 0.92 (H8, end groups overlapping) ppm. ¹³C{¹H} NMR (75 MHz, CDCl₃, 298 K) δ=148.4 (C4); 142.8 (C16); 129.4, 129.4, 128.3, 127.9, 126.0 (C2, C16, C17 overlapping); 117.3 (C1); 112.9 (C3); 48.4 (C6); 38.0 (C7); 32.9 (C18 & C21-trans); 34.4, 30.6, 29.8, 22.7, (C9-Cl₂ overlapping); 27.7 (C18 & C21-trans); 16.7, 14.3 (C8) ppm. Unobserved: C17. FIG. 9A showed ¹H NMR spectrum of Compound 9. FIG. 9B showed ¹³C{¹H} NMR spectrum of Compound 9. FIG. 9C showed ¹H-¹H COSY NMR spectrum of Compound 9. FIG. 9D showed ¹H-¹³C{¹H} HSQC NMR spectrum of Compound 9. FIG. 9E showed ¹H-¹³C{¹H} HMBC NMR spectrum of Compound 9.

### Example 9: Hydrogenation

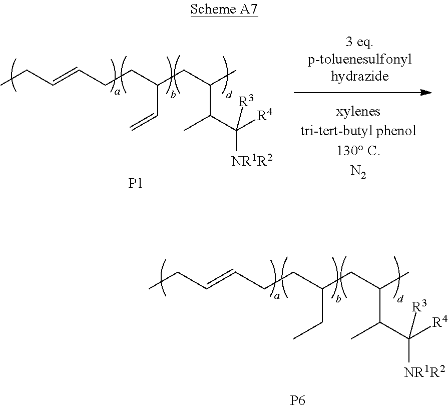

Scheme A7. In certain embodiments, the functionalized polymer can be subjected to hydrogenation reaction conditions to give saturated polymer backbone. In certain embodiments, the saturate the polymer backbone products are typically expected to exhibit greater thermo-oxidative stability. In certain embodiments, subjecting polymer P1 under appropriate hydrogenation conditions will furnish saturated polymer P6.

### Example 10: Synthesis of P6

A Schlenk flask charged with P1 (500 mg, 0.088 mmol) was heated to 100° C. in vacuo overnight to dry and degas the compound. A thick-walled vessel was charged with tosylhydrazide (2.9 g, 15.6 mmol) and was dried in vacuo overnight. Tripropylamine (TPA) was dried over CaH₂, distilled, and degassed by three cycles of freeze-pump-thaw prior to use. Xylenes were dried over CaH₂, distilled, and degassed by three freeze-pump-thaw cycles prior to use. 3 mL of xylenes was transferred to the Schlenk flask to dissolve P1 and the solution was transferred to the thick-walled vessel containing the dried tosylhydrazide. An additional 6 mL of xylenes was added to the reaction vessel by syringe. TPA (1.9 mL, 10.0 mmol) was transferred to the thick-walled reaction vessel by syringe technique. The vessel was sealed under N₂ with an airtight PTFE valve and was heated to 130° C. for 24 hours. The reaction was removed from heat and cooled to room temperature. The solution was collected in a separatory funnel along with 20 mL of dichloromethane (DCM). The organic layer was washed three times with 15 mL of 1 M NaOH. The aqueous layer was washed once with 20 mL DCM and the organic layers were collected and combined. The organic layers were dried over MgSO₄, filtered by gravity filtration and concentrated under reduced pressure. The product was precipitated from a concentrated DCM solution into cold MeOH to remove the para-toluene sulfonic acid by-product. The product P6 was collected and dried in vacuo to afford a dark red viscous oil (0.443 mg, 86%). ¹H NMR spectrum (300 MHz, CDCl₃) of product P6 (FIG. 10). δ=7.26, 6.78, 6.76, 6.58, 6.55, 3.74, 3.03, 3.02, 2.86, 2.32, 1.85, 1.62, 1.26, 1.23, 1.10, 1.08, 0.83, 0.08 ppm.

### Example 11: Reduction of Branched P-Methoxy Arylamine to Branched Primary Amine Product

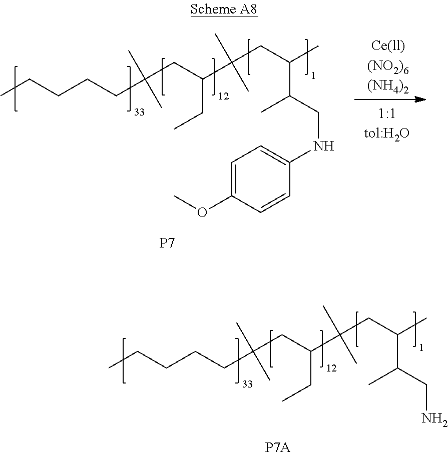

Scheme A8. In certain embodiments, the functionalized polymer can be subjected to reduction reaction conditions to give primary amine products.

### Synthesis of P7A

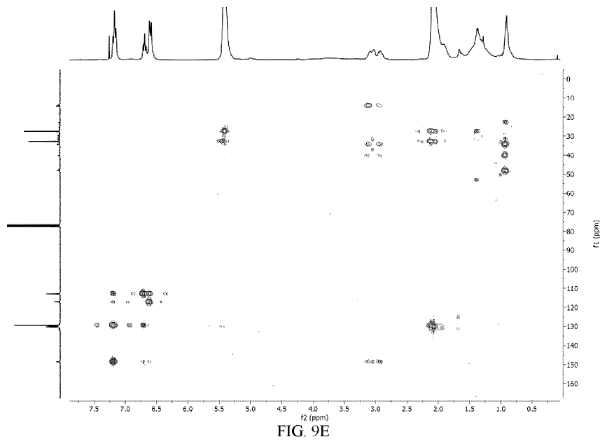

P7 (0.500 g, 0.190 mmol) was weighed into a round bottom flask and dissolved in 2 mL of toluene. Ammonium cerium(II) nitrate was added neat, followed by addition of 2 mL of deionized water. The reaction was stirred overnight at room temperature. The dark purple solution was concentrated under reduced pressure then the product was isolated by filtering a dichloromethane solution through a short Celite and activated carbon plug. The solution was dried in vacuo, and the product P7A was isolated as a dark brown oil in 43% yield. By ¹H NMR spectroscopy no aryl signals were observed (FIG. 11). ¹H NMR spectrum (300 MHz, CDCl₃) δ=7.26, 5.65, 5.56, 5.50, 5.42, 5.38, 4.96, 4.92, 2.24, 2.07, 2.03, 1.65, 1.64, 1.59, 1.43, 1.30, 1.28, 1.28, 1.26, 1.01, 0.91, 0.88, 0.87, 0.83, 0.07 ppm.

### Example 12: General Scheme: Epoxide Ring-Opening

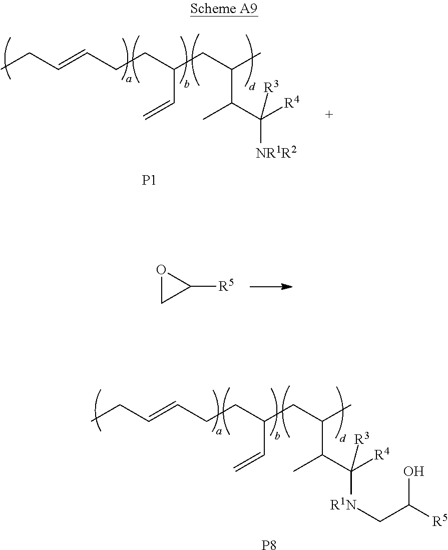

Scheme A9. In certain embodiments, the functionalized polymer can react with epoxides. In certain embodiments the functionalized polymer can be used to perform epoxide-ring opening. The ring-opening of epoxides is a key step in the curing process of epoxy-based resins used for adhesives and coatings.

### Example 13: Epoxide Ring-Opening of Poly(Ethylene Glycol) Diglycidyl Ether

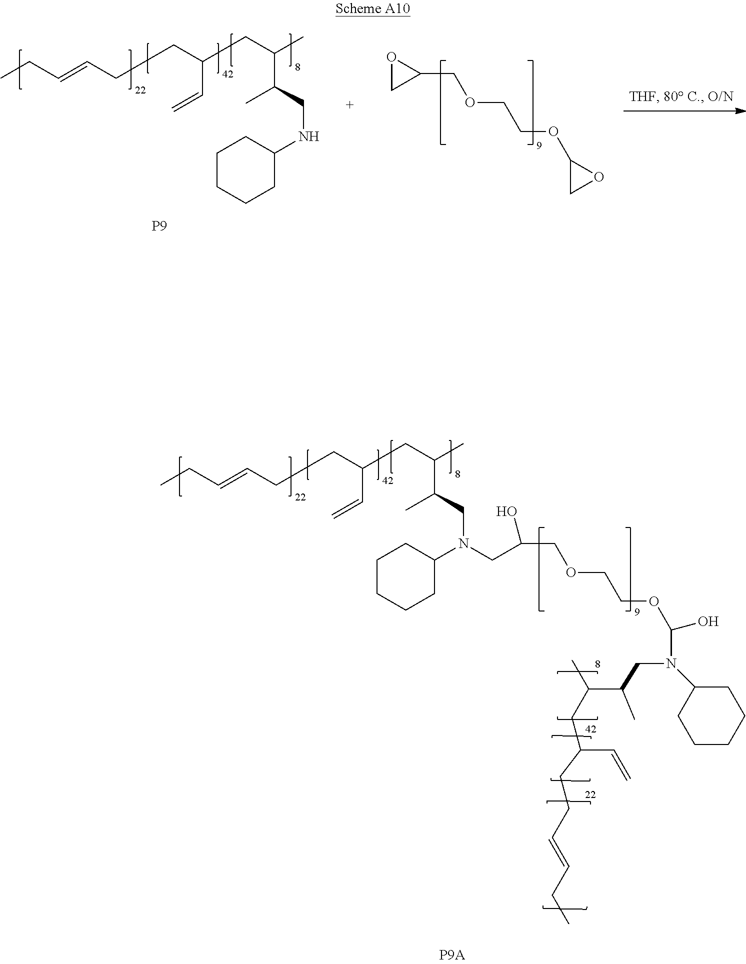

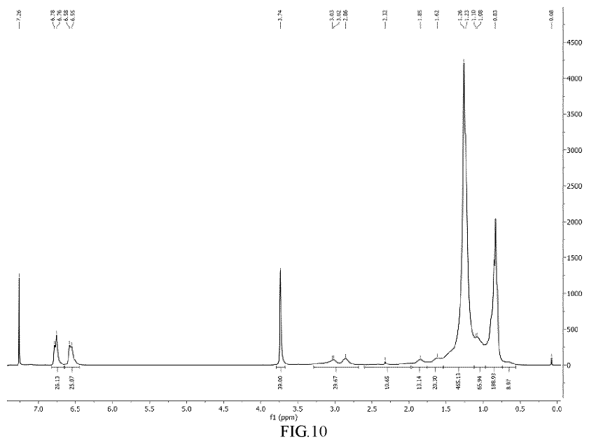

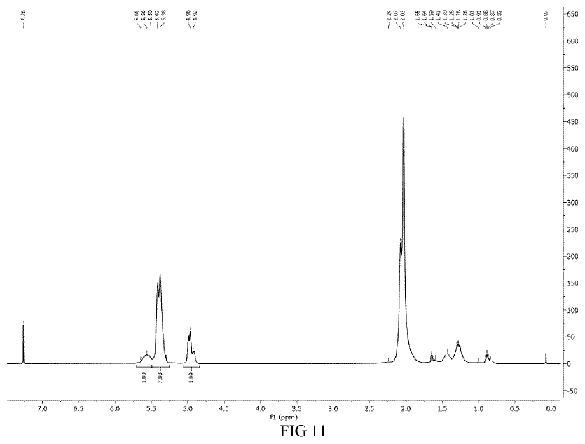

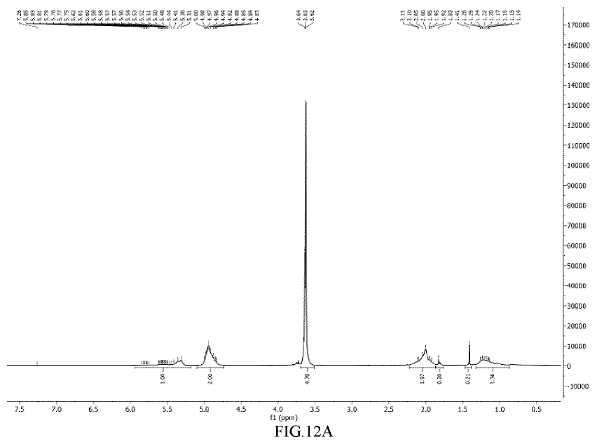

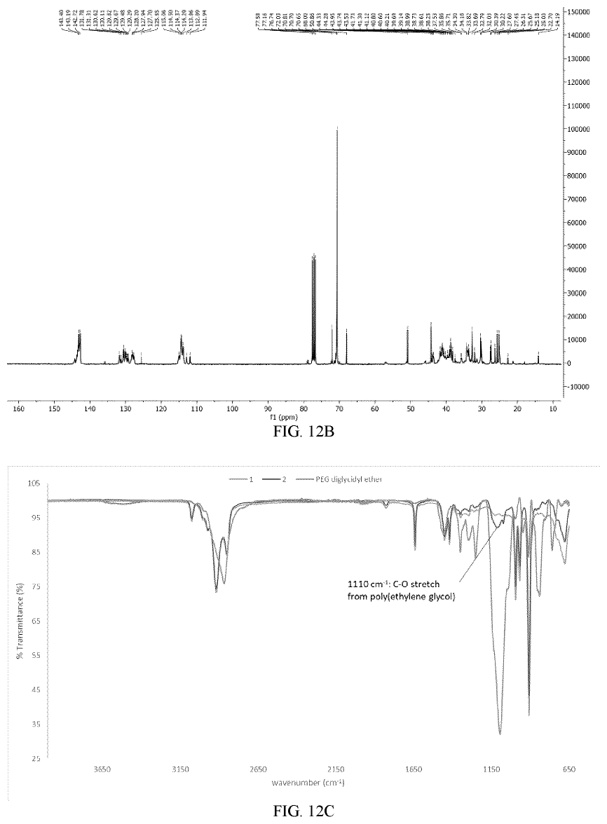

Scheme A10. P9 (0.254 g, 0.053 mmol) was weighed into a round bottom flask and dissolved in 3 mL THF. The poly(ethylene glycol) diglycidyl ether (0.052 g, 0.104 mmol) was weighed separately, and was quantitatively transferred into the flask containing the amine-functionalized polybutadiene as a solution in 2 mL THF. The solution was stirred at room temperature overnight resulting in minimal conversion, as observed by ¹H NMR spectroscopy of an aliquot of the solution. The reaction solution was then heated to 80° C. overnight resulting in nearly quantitative conversion. FIG. 12A shows ¹H NMR (300 MHz, CDCl₃, 298 K) spectrum of P9A. FIG. 12B shows ¹³C NMR (75 MHz, CDCl₃, 298 K) spectrum of P9A. FIG. 12C shows IR spectrum of P9A.

### Example 14: Epoxide Ring-Opening of Trimethylolpropane Triglycidyl Ether

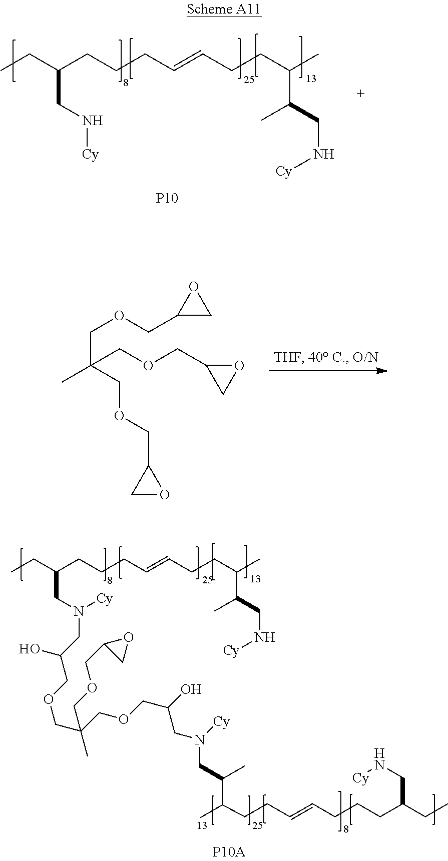

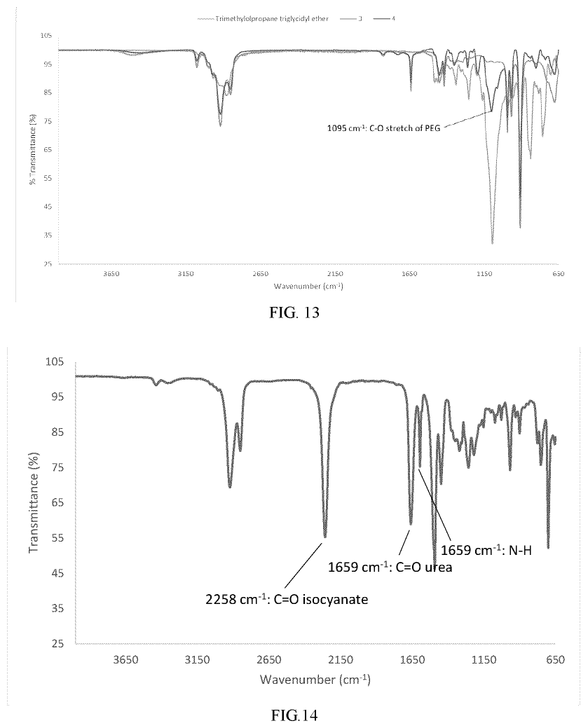

Scheme A11. The amine-functionalized polybutadiene (0.650 g, 0.135 mmol) was weighed into a Schlenk flask and dissolved in 5 mL THF. Trimethylolpropane triglycidyl ether (1 mL, 3.83 mmol) was added via syringe. The solution was heated to 40° C. overnight and formed an orange solid gel-like insoluble material. FIG. 13 shows the overlaid IR spectrum of P10 and P10A.

### Example 15: Isocyanate Reactivity to Generate Polyureas

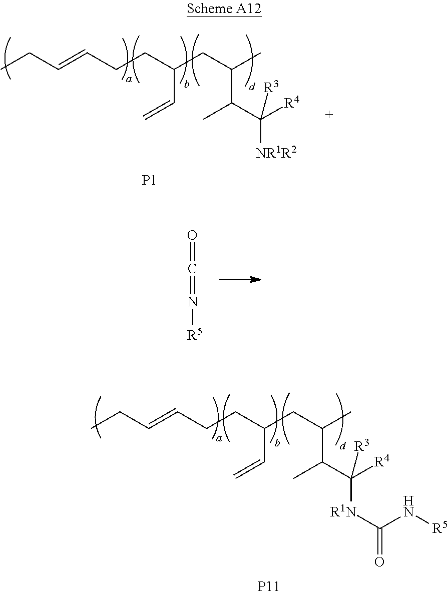

Scheme A12. In certain embodiments, the functionalized polymer can react with isocyanates. The reaction between amine and isocyanate functional groups can create urea functional groups. In some embodiments, R⁵ is hydrogen, —C₁-C₂₀ alkyl or —C₆-C₂₀ aryl. In some other embodiments, R⁵ is —C₁-C₆ alkyl, —C₁-C₆ heteroalkyl, C₄₋₁₀aryl, and C₄₋₁₀heteroaryl.

### Example 16: Reaction with 4,4′-Methylene Bis(Cyclohexyl Isocyanate)

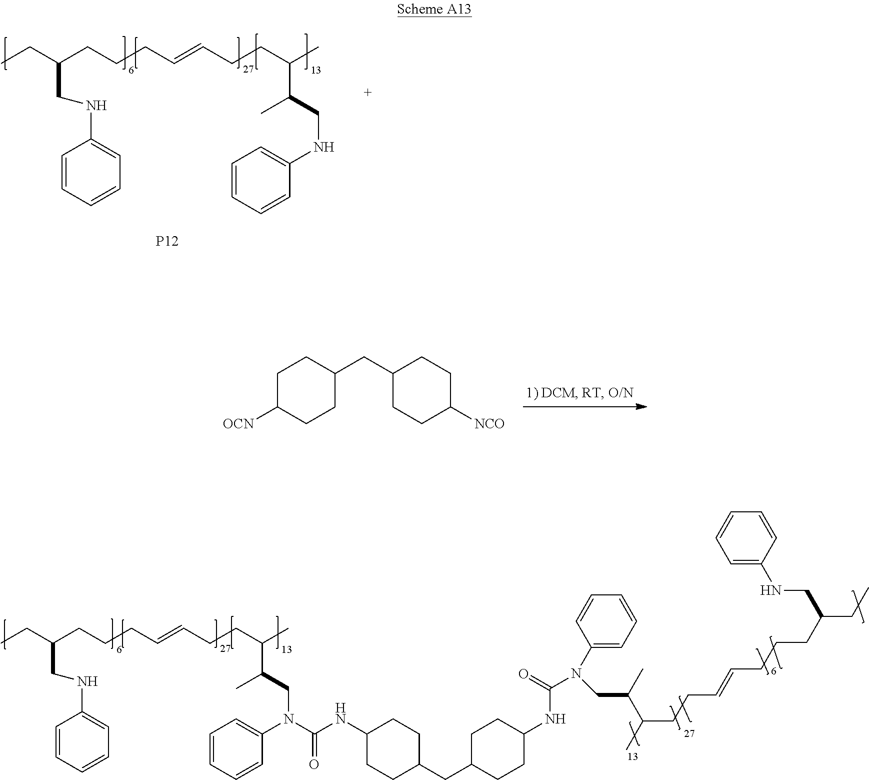

Scheme A13. P12 (0.25 g, 0.055 mmol) was weighed into a round bottom flask and dissolved in 3 mL of DCM. 4,4′-Methylene bis(cyclohexyl isocyanate) (1.3 mL, 5.28 mmol) was transferred into the reaction flask via syringe. The solution was stirred at room temperature overnight. The next morning the material was concentrated under reduced pressure resulting in a hard, brittle, insoluble material P12A. Product was characterized by FTIR spectroscopy (FIG. 14).

### Example 17: Reaction with Tosylated Polyethylene Glycol

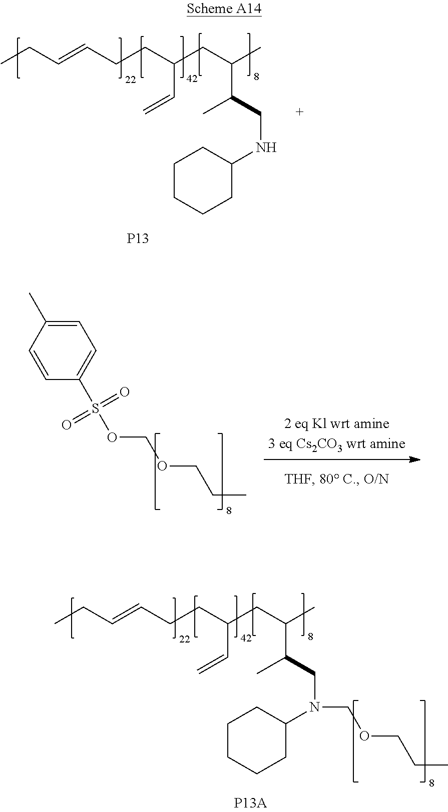

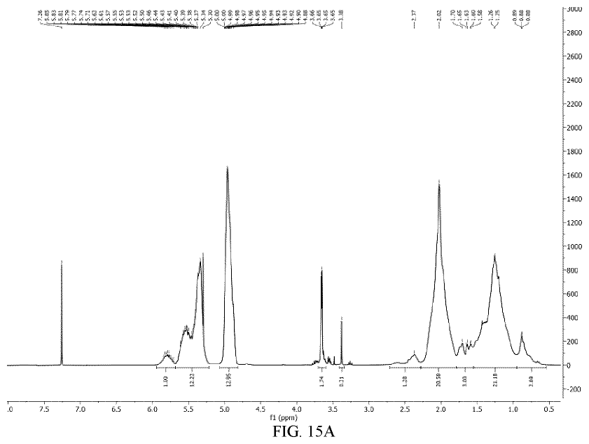

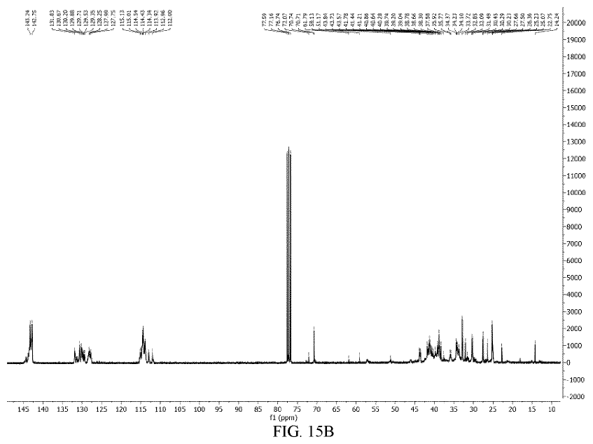

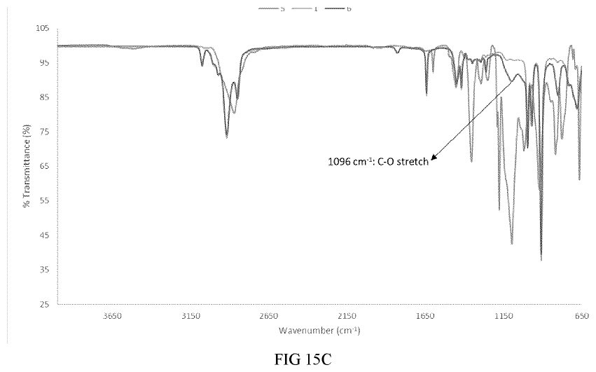

Scheme A14. P13 (290 mg, 0.060 mmol) was weighed into a round bottom flask and dissolved in 3 mL THF. The tosylated polyethylene glycol (180 mg, 0.43 mmol) was weighed separately and was transferred into the round bottom flask containing P13 quantitatively with 2 mL THF. KI (0.138 g, 0.83 mmol) and Cs2SO3 (0.407 mg, 0.13 mmol) were weighed separately and added directly into the round bottom flask. The solution was stirred and refluxed overnight. An off-white precipitate formed overnight. The solution was cooled to room temperature then filtered through a 1-inch Celite® pad. The resulting solution was concentrated under reduced pressures then dissolved into DCM to perform a liquid-liquid extraction with DI-H₂O. The organic layer was collected and condensed under reduced pressures. The resulting product was redissolved into a concentrated DCM solution and precipitated into MeOH. The insoluble material was collected by collecting as a solution in DCM after decanting the MeOH. The product was concentrated under reduced pressures then dried overnight in vacuo. FIG. 15A shows ¹H NMR (300 MHz, CDCl₃, 298 K) spectrum of P13A. FIG. 15B shows ¹³C NMR (75 MHz, CDCl₃, 298 K) spectrum of P13A. FIG. 15C shows IR spectrum of P13A.

### Example 18: Preparation of Quaternary Amine Groups Using Methyl Iodide

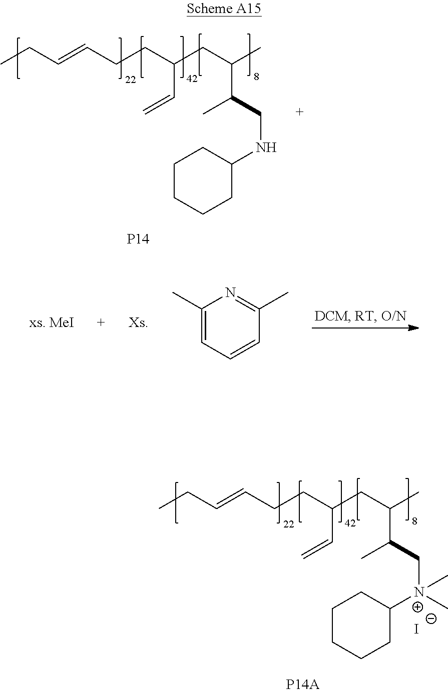

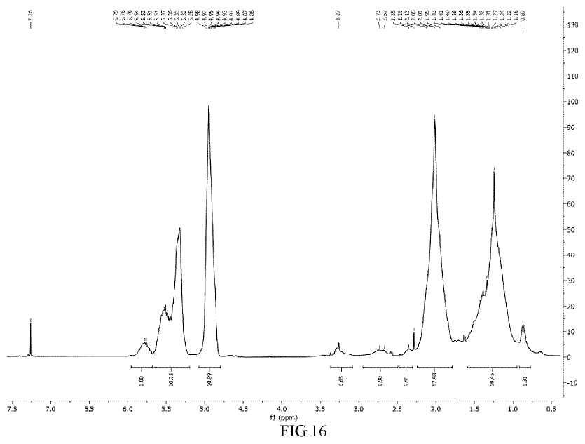

Scheme A15. P14 (0.252 g, 0.053 mmol) was weighed into a round bottom flask and dissolved in 3 mL DCM. Iodomethane (0.1 mL, 1.55 mmol) and 2,6-lutidine (0.15 mL, 1.30 mmol) were added to the reaction vessel via syringe. The solution was stirred at room temperature overnight. A precipitate formed and was removed by filtration through Celite. The solution was concentrated under reduced pressure, resulting in further precipitates. These were removed by filtration with hexanes over Celite. The solution was concentrated under reduced pressures and dried in vacuo overnight to afford P14A (247 mg, 92%). FIG. 16. ¹H NMR (300 MHz, CDCl₃, 298 K) spectrum of P14A.

### Example 19: Scheme: Reaction with Benzyl Chloride

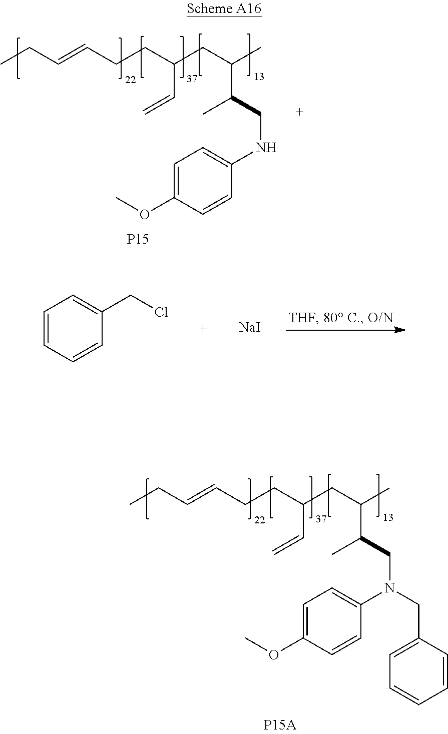

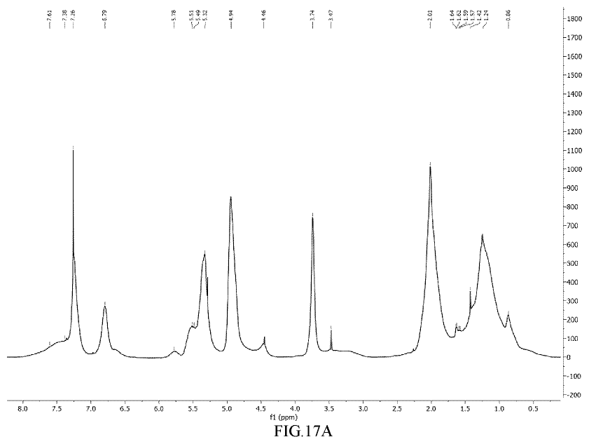

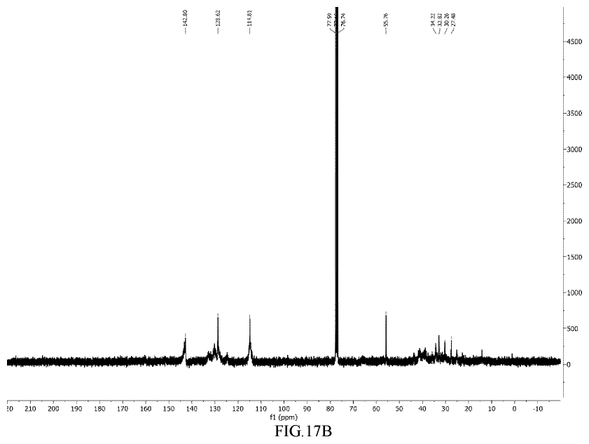

Scheme A16. P15 (251 mg, 0.044 mmol) was weighed into a round bottom flask and dissolved in 3 mL THF. Sodium iodide (0.097 mg, 0.647 mmol) was weighed separately and added to the reaction flask neat. Benzylchloride (0.077 mL, 0.669 mmol) was supplied to the reaction flask via syringe. The solution was mixed vigorously and was refluxed overnight. A precipitate formed and was removed by filtration through Celite. The solution was condensed under reduced pressures and the product was precipitated from a concentrated DCM solution into cold MeOH. The MeOH was decanted and the product was collected in a vial with DCM, concentrated under reduced pressure and brought to dryness in vacuo overnight night. The resulting material P15A was hard and amber in color (0.077 g, 25%). FIG. 17A. ¹H NMR (300 MHz, CDCl₃, 298 K) spectrum of P15A. FIG. 17B. ¹³C{1H}NMR (75 MHz, CDCl₃, 298 K) spectrum of P15A.

### Example 20: Reaction with Triphosgene

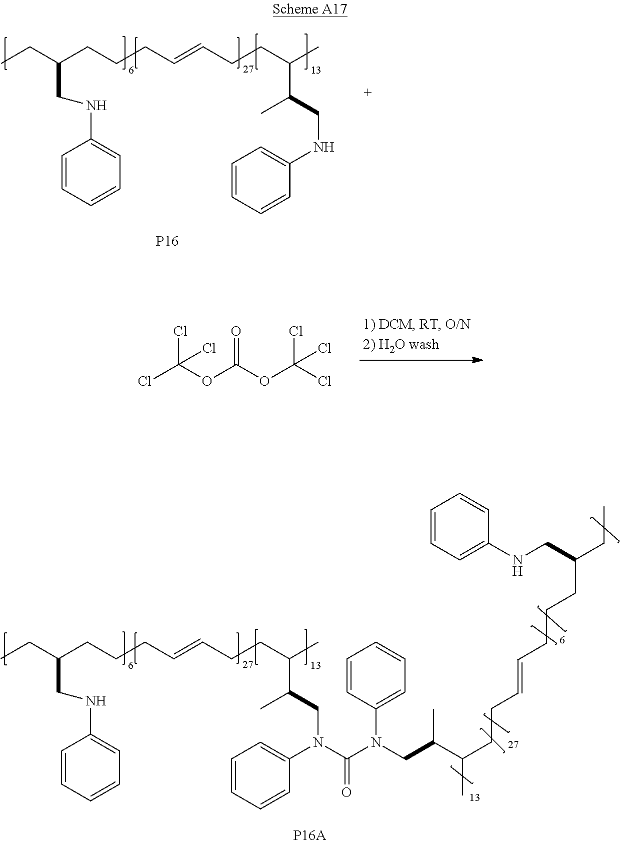

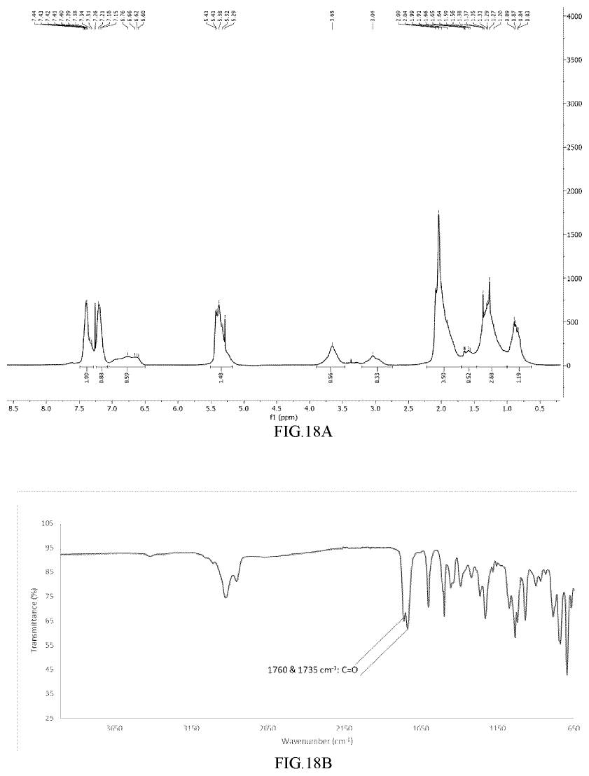

Scheme A17. P16 (0.25 g, 0.055 mmol) was weighted into a round bottom flask and dissolved in 3 mL DCM. Triphosgene (0.77 g, 0.26 mmol) was weighted separately in a sealed vial then added to the reaction vessel neat. The solution was stirred at room temperature overnight. The next morning the solution was washed with deionized H₂O (3×5 mL) and the organic layer was collected and dried over MgSO₄. The solution was gravity filtered and condensed under reduced pressure prior to drying in vacuo overnight. The resulting material P16A was oily, sticky, and brown (0.22 g, 84%). FIG. 18A. ¹H NMR (300 MHz, CDCl₃, 298 K) spectrum of P16A. FIG. 18B. FT-IR spectrum of P16A.

### Example 21: Reaction with Linoleic Acid

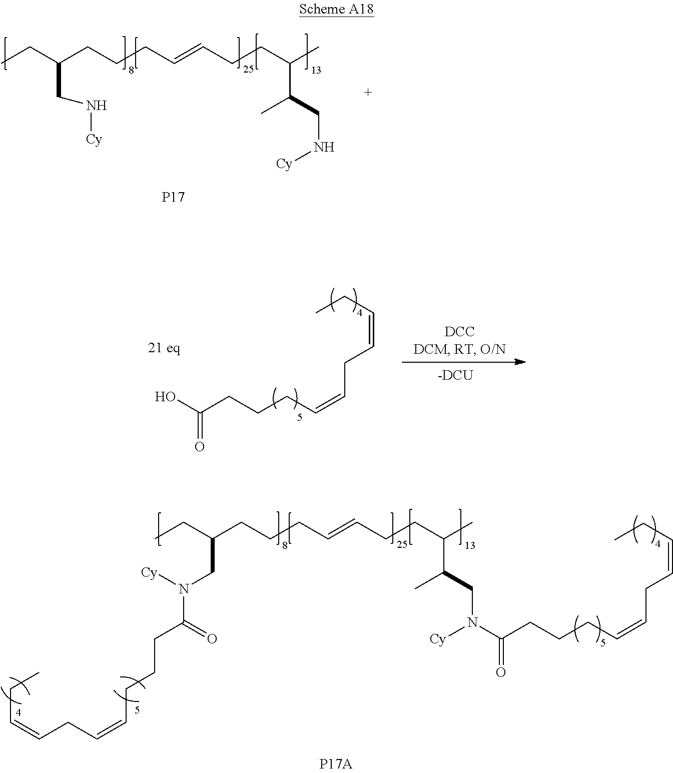

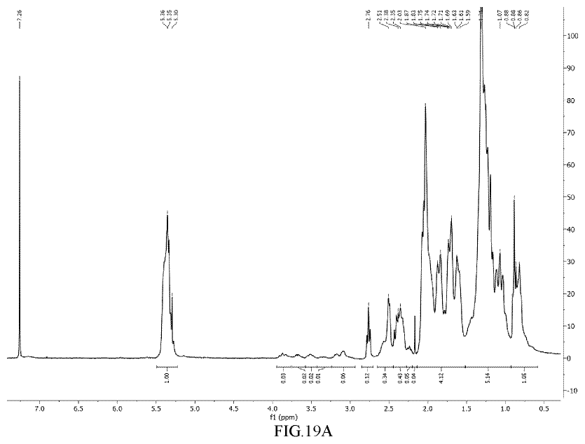

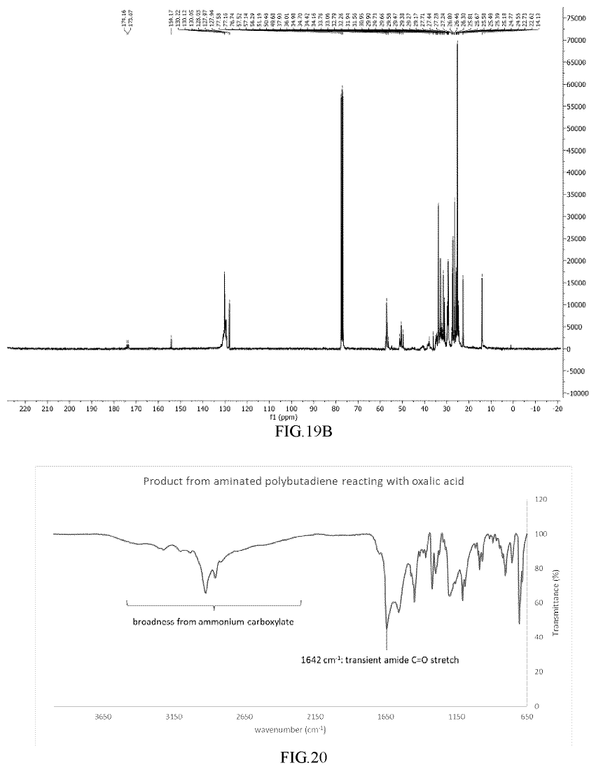

Scheme A18. P17 (0.102 g, 0.0210 mmol) was weighed into a round bottom flask. Linoleic acid (0.121 g, 0.431 mmol) was weighted separately and transferred into the round bottom flask with DCM, quantitatively. The two were mixed for 1 h, then N,N′-dicyclohexylcarbodiimide (DCC) (0.095 g, 0.46 mmol) was added, neat. The reaction was stirred overnight at room temperature. The next morning the solution was cloudy and white, the precipitate (N,N′-dicyclohexylurea-DCU) was removed by filtration. The product, P17A, was concentrated under reduced pressures and was precipitated from a concentrated DCM solution into acetone. This formed a persistent dispersion, the product was separated by centrifugation, and the acetone was decanted off the product. The product P17A was isolated in 0.156 g (0.0145 mmol, 69%) as a yellow oil. FIG. 19A. ¹H NMR (300 MHz, CDCl₃, 298 K) spectrum of P17A. FIG. 19B. ¹³C{1H} NMR (75 MHz, CDCl3, 298 K) spectrum of P17A.

### Example 22: Reaction with Oxalic Acid to Obtain pH-Responsive Materials

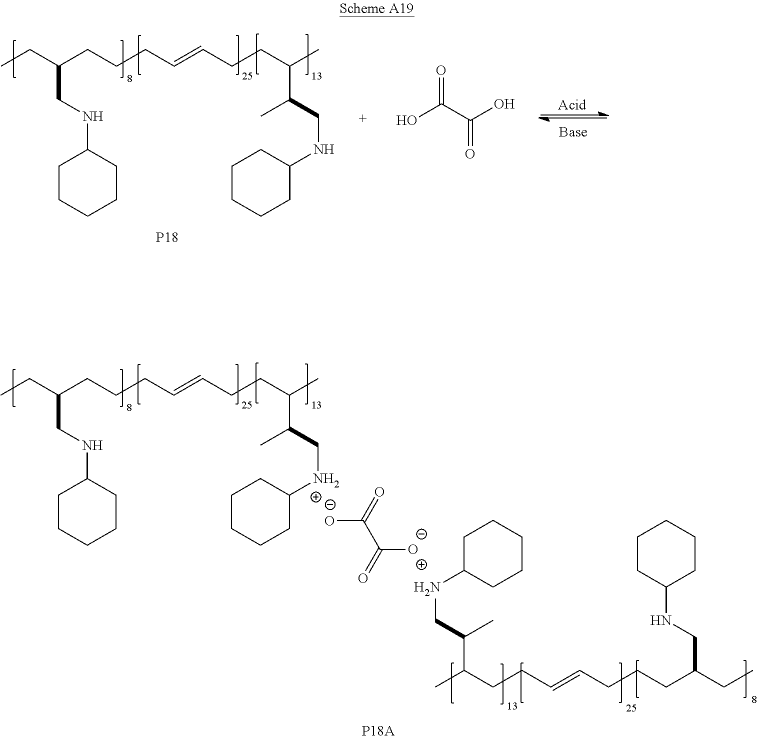

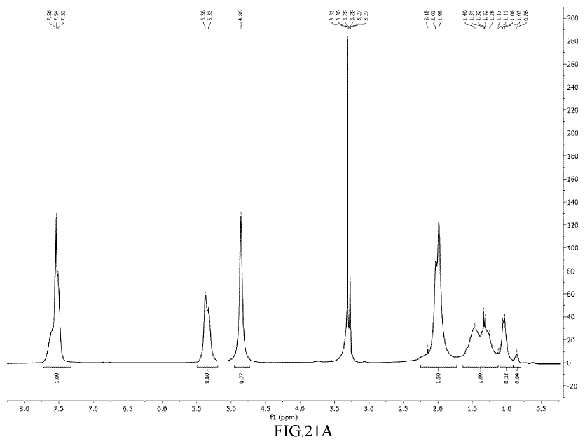

Scheme A19. P18 (0.50 g, 0.10 mmol) was weighed into a round bottom flask and dissolved in hexanes. Oxalic acid (0.10 g, 1.1 mmol) was weighted separately and transferred into the round bottom flask, with 0.1 mL MeOH. 1 minute after addition a white solid waxy precipitate formed at the bottom of the round bottom flask. This precipitate persisted. Then, 1 mL of 1,8-Diazabicyclo[5.4.0]undec-7-ene (DBU) was added and the precipitate redissolved immediately. The solution remained homogenous. Then excess oxalic acid was added to the solution and the precipitate reformed and the supernatant became clear after 10 minutes. The product P18A was insoluble in most organic solvents (hexanes, MeOH, EtOAc, CDCl₃). FIG. 20. FT-IR spectrum of P18A.

### Example 23: Reaction with Hydrochloric Acid

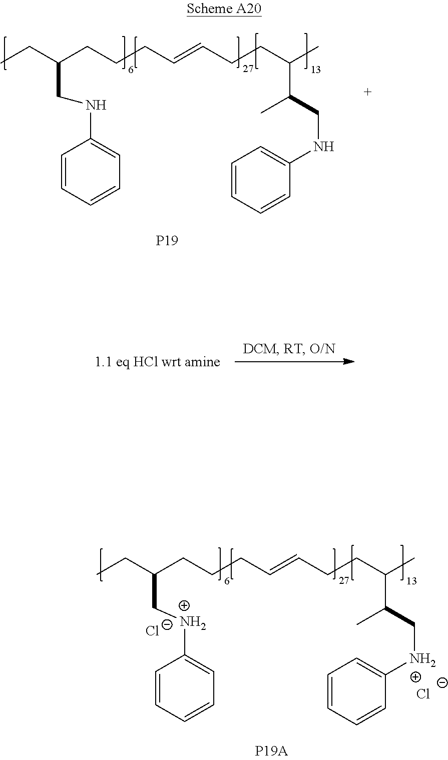

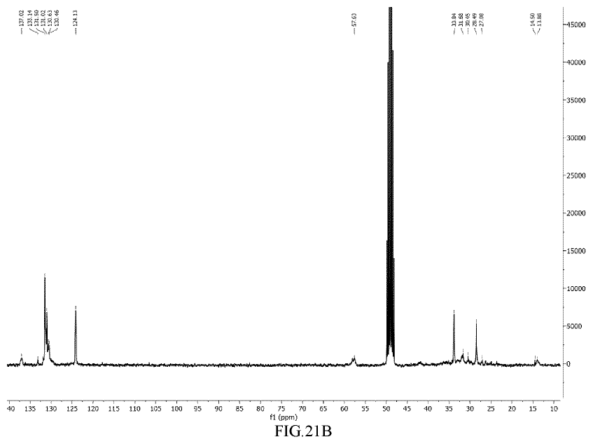

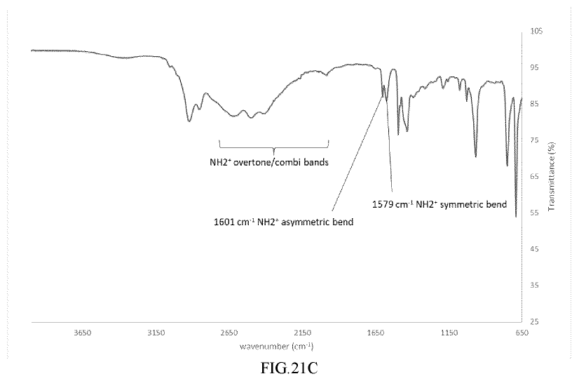

Scheme A20. P19 (0.29 g, 0.064 mmol) was weighed into a round bottom flask and dissolved in 3 mL DCM. 0.61 mL of 2.0 M HCl in ether was transferred to the reaction flask via syringe. An insoluble precipitate immediately formed, and the reaction was left to stir overnight at room temperature. The next morning the solvents were removed under reduced pressure and the material was dried in vacuo overnight to afford a solid, flaky, amber colored material P19A (0.306 g, 0.059 mmol). FIG. 21A. ¹H NMR (300 MHz, CD30D, 298 K) spectrum of P19A. FIG. 21B. ¹³C{1H} NMR (75 MHz, CD30D, 298 K) spectrum of P19A. FIG. 21C. FT-IR spectrum of P19A.

### Example 24: Reaction with Polybutadiene Having Varied Molecular Weights

The following reaction was conducted for polybutadiene starting materials having a varied molecular weight:

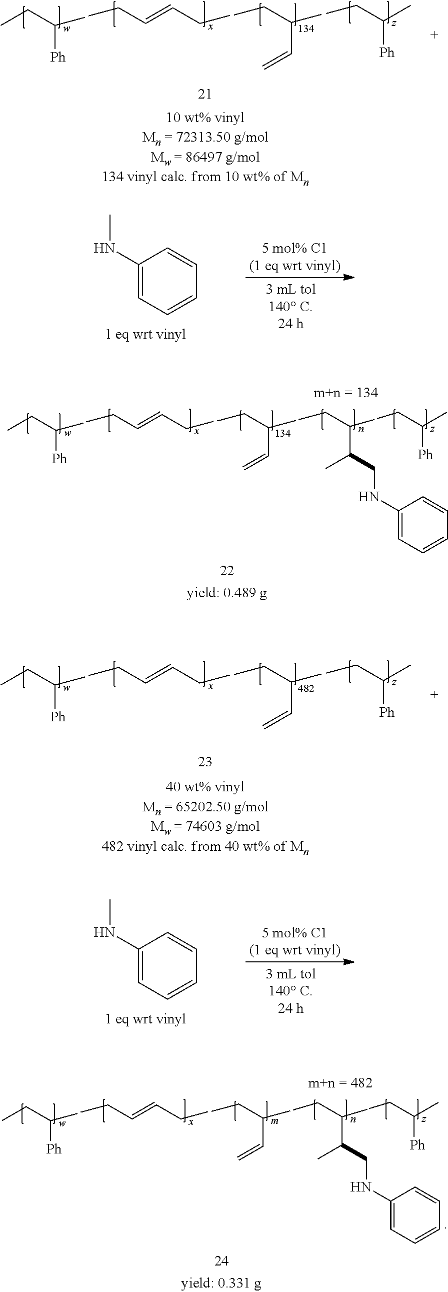

### Example 25: Reaction with Acid Anhydrides

The following reaction was conducted.

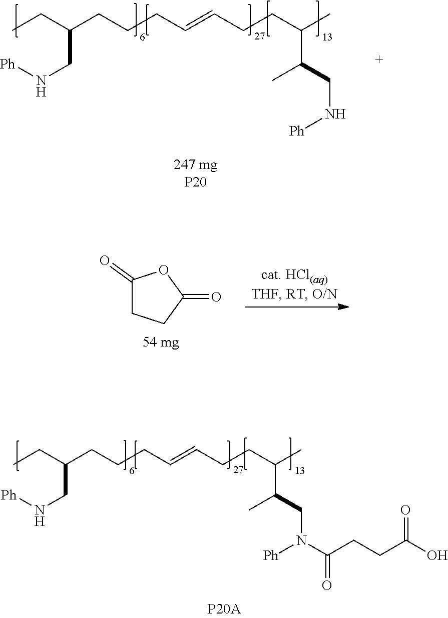

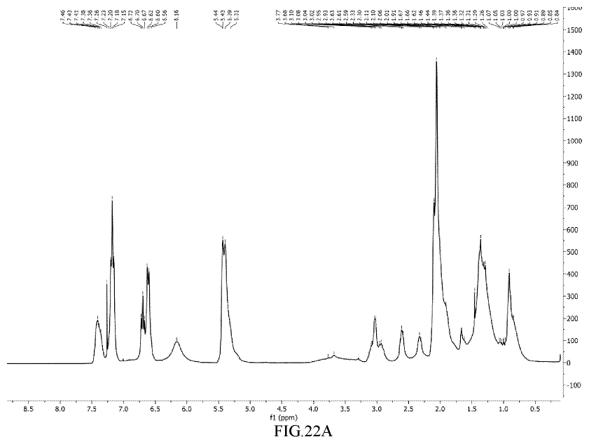

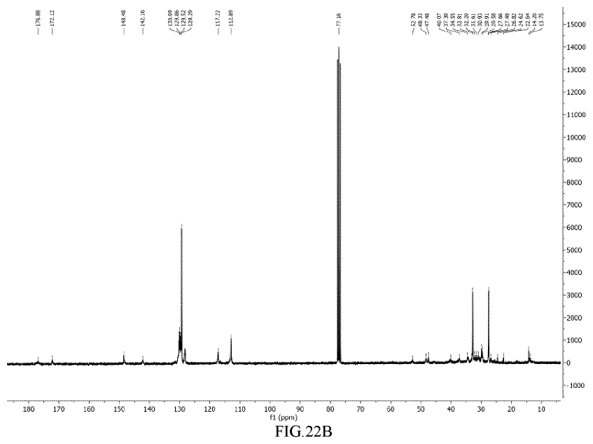

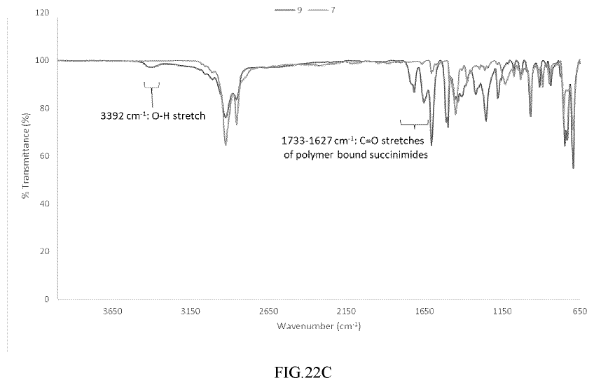

P20 (0.247 g, 0.055 mmol) was weighed into a round bottom flask then dissolved in 3 mL THF. Then succinic anhydride (0.054 g, 0.540 mmol) was weighed separately and added to the solution. 2 drops of 1 M HCl_{(aq)} was add to the solution. The solution was stirred overnight at room temperature. The solution was concentrated under reduced pressures, then the viscous product was dissolved into a concentrated DCM solution and precipitated into DI-H₂O. The DI-H₂O was decanted, and the product was collected as a solution of DCM and was concentrated under reduced pressure then dried overnight in vacuo, to afford P20A (0.262 g). FIG. 22A. ¹H NMR (300 MHz, CD30D, 298 K) spectrum of P20A. FIG. 22B. ¹³C{1H} NMR (75 MHz, CD30D, 298 K) spectrum of P20A. FIG. 22C. FT-IR spectrum of P20A.

The embodiments and examples described above are intended to be merely illustrative and non-limiting. Ordinarily skilled artisans will recognize, or will be able to ascertain using no more than routine experimentation, numerous equivalents of specific compounds, materials and procedures. All such equivalents are considered to be within the scope and are encompassed by the appended claims.

1. A polymer comprising:
a polybutadiene backbone;
1,2-alkene units;
1,4-alkene units; and
a branched-substitution unit having a functional group of Formula (I) or a salt thereof: 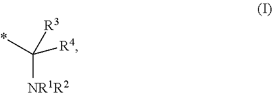
a linear-substitution unit having a functional group of Formula (I) or a salt thereof:
wherein the molar ratio of the branched-substitution unit to the linear-substitution unit is 6:1 or greater;
R¹ is hydrogen, —C₁-C₂₀ alkyl, or —C₆-C₂₀ aryl;
R² is —C₁-C₂₀ alkyl or C₆-C₂₀ aryl; or
R¹ and R² together with the nitrogen to which they are both attached form a —C₃-C₂₀ heterocyclic ring having 0 to 2 additional heteroatoms selected from nitrogen and oxygen,
wherein R¹ and R² are each independently optionally substituted with one to six groups selected from —F, —C₁, —I, —Br, —OH, —OCH₃, —OCF₃, and —C₁-C₆ thioalkyl, or a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises one or more other units; and
wherein the units may be ordered in series, in blocks, or randomly distributed.

2. The polymer of claim 1, wherein the polymer contains at least 60% branched-substitution units relative to linear-substitution units.

3. The polymer of claim 1, wherein the amounts of 1,2-alkene units and 1,4-alkenes units may be equal or variable.

4. The polymer of claim 1, comprising 92% 1,4-alkene units and 8% 1,2-alkene units.

5. The polymer of claim 1, wherein the one or more other units comprise styrene units optionally substituted with alkyl, substituted alkyl, heteroalkyl, substituted heteroalkyl, styrene, substituted styrene, or mixtures thereof.

6. The polymer of claim 1, wherein the one or more other units comprise styrene units.

7. The polymer of claim 1, wherein the one or more other units is an isoprene unit.

8. The polymer of claim 1, wherein R² is —C₆-C₂₀aryl and the aryl group in R² is para-substituted.

9. The polymer of claim 1 according to Formula (II) 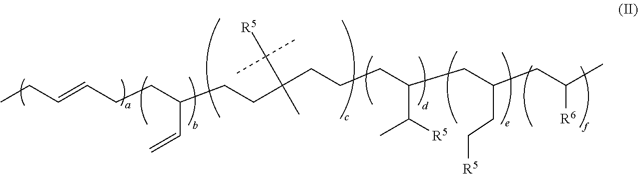
or a fragment thereof, wherein
R⁵ is present or absent;
when R⁵ is present on the c unit, the dashed line indicates a single bond, and when R⁵ is absent on the c unit, the dashed line indicates a double bond;
R⁵ has the structure of Formula (I) or a salt thereof: 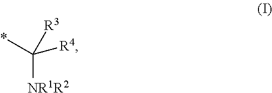
wherein
R¹ is —C₁-C₂₀ alkyl or —C₆-C₂₀ aryl; or
R² is hydrogen, —C₁-C₂₀ alkyl, or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R³ and R⁴ are each independently optionally substituted with one to six members selected from the group consisting of —F, —C₁, —I, —Br, —OCH₃, —OCF₃, —C₁-C₆ thioalkyl, and a combination thereof,
wherein the aryl group in R² is optionally para-substituted;
R³ and R⁴ are, independently in each instance selected from hydrogen, —C₁-C₆ alkyl, or and —C₁-C₆ heteroalkyl;
R⁶ is hydrogen, —C₁-C₂₀ alkyl, —C₆-C₂₀ aryl, —C₁₋₆alkyl-C₁-C₂₀ alkyl, —C₁₋₆alkyl-C₆-C₂₀ aryl, —C₁₋₆heteroalkyl-C₁-C₂₀ alkyl, or —C₁₋₆heteroalkyl-C₆-C₂₀ aryl; and
a, b, c, d, e, and f are independently at each occurrence an integer from 0 to 100,000; wherein the
ratio of d:e is 6:1 or greater, wherein the units may be ordered or randomly distributed.

10. The polymer of claim 9, wherein the ratio of a:b is 0.1, 0.5, 1, 1.5, 2, or 10.

11. The polymer of claim 1, wherein the ratio of d:e is 6:1.

12. (canceled)

13. The polymer of claim 9 having the structure of Formula (IIa)

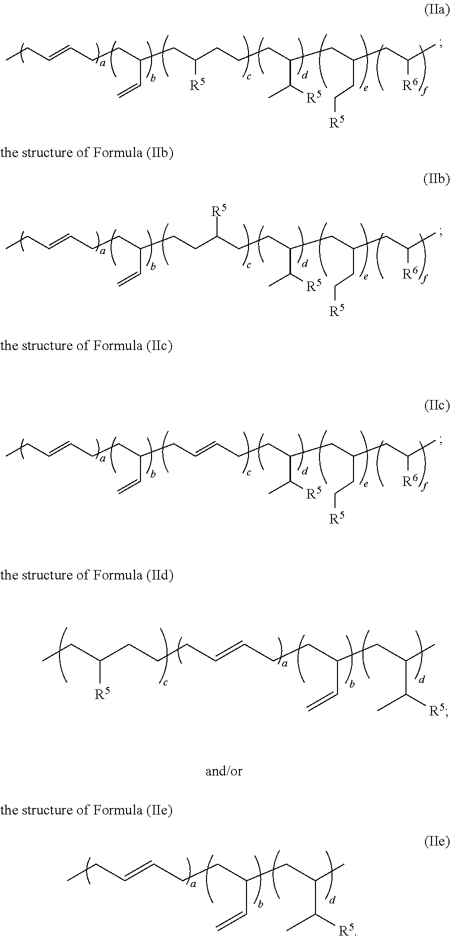

14. (canceled)

15. (canceled)

16. (canceled)

17. (canceled)

18. The polymer of claim 1, selected from the group consisting of the following compounds:

| Com - | |
|---|---|
| pound | |
| No. | Structure |
| 1 | 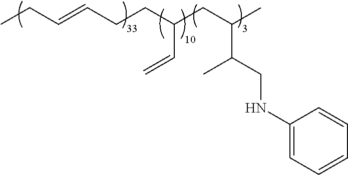 |
| 2 | 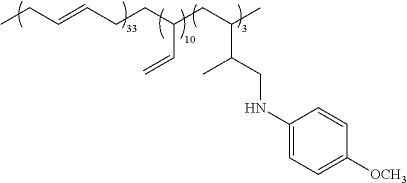 |
| 3 | 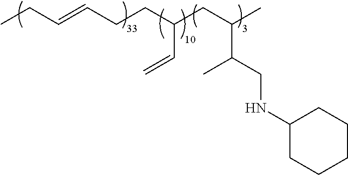 |
| 4 | 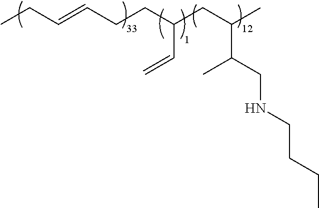 |
| 5 | 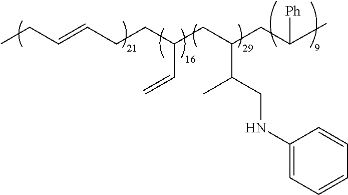 |
| 6 | 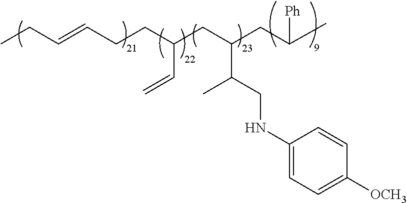 |
| 7 | 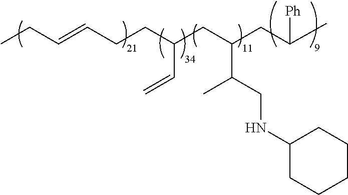 |
| 8 | 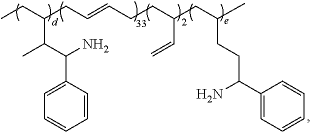 |
| | wherein the sum of subscript d and e is 9; and |
| 9 | 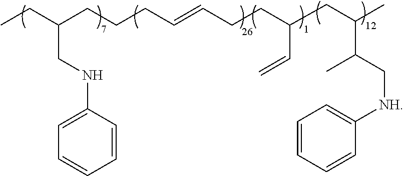 |

19. (canceled)

20. (canceled)

21. The polymer of claim 1 having the following structure: 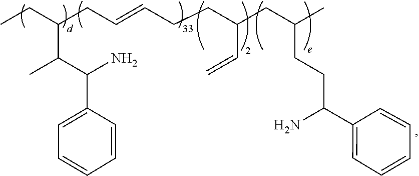
wherein the sum of subscript d and e is 9.

22. The polymer of claim 1, wherein the polymer has a molecule weight of 2,500 to 4,500 g/mol.

23. The polymer of claim 1, wherein the polymer has a molecule weight of 70,000 to 80,000 g/mol.

24. A process for making a polymer comprising:
hydroaminoalkylating a polybutadiene polymer post-polymerization in the presence of a of group 4 or 5 transition metal catalyst and a secondary amine to form a functionalized polymer, wherein the reaction temperature is 110° C.-165° C.,
producing the functionalized polymer comprising:
a polybutadiene backbone;
1,2-alkene units,
1,4-alkene units; and
a branched-substitution unit having a functional group of Formula (I) or a salt thereof: 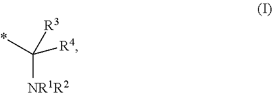
a linear-substitution unit having a functional group of Formula (I) or a salt thereof:
wherein the molar ratio of the branched-substitution unit to the linear-substitution unit is 6:1 or greater;
R¹ is hydrogen, —C₁-C₂₀ alkyl, or —C₆-C₂₀ aryl;
R² is-C₁-C₂₀ alkyl or —C₆-C₂₀ aryl; or
R¹ and R² together with the nitrogen to which they are both attached form a —C₃-C₂₀ heterocyclic ring having 0 to 2 additional heteroatoms selected from nitrogen and oxygen, wherein R¹ and R² are each independently optionally substituted with one to six members selected from the group consisting of —F, —C₁, —I, —Br, —OCH₃, —OCF₃, —C₁-C₆ thioalkyl, and a combination thereof;
R³ and R⁴ are, independently in each instance selected from hydrogen, —C₁-C₆ alkyl, and —C₁-C₆ heteroalkyl;
an asterisk (*) denotes the point of attachment of the functional group to a carbon atom in the polymeric backbone;
wherein the polymer optionally comprises one or more other units; and
wherein the units may be ordered or randomly distributed.

25-83. (canceled)

84. A process for preparing a functionalized polymer, comprising:
preparing a reaction mixture comprising a polymer of claim 1 and an electrophile; and
reacting the polymer with the electrophile to produce the functionalized polymer.

85.-100. (canceled)
